(19) United States
(12) Patent Application Publication
(10) Pub. No.: US 2002/0111725 A1
(43) Pub. Date: Aug. 15, 2002

(54) Method and apparatus for risk-related use of vehicle communication system data

(76) Inventor: John R. Burge, Redondo Beach, CA (US)

Correspondence Address: Eric K. Satermo, Registered Patent Agent, P.O. Box 19099, Irvine, CA, 92623-9099, US

(21) Appl. No.: 09/907,545

(22) Filed: Jul. 16, 2001

Related U.S. Application Data
(60) Provisional application No. 60/218,576, filed on Jul. 17, 2000.
(60) Provisional application No. 60/218,577, filed on Jul. 17, 2000.
(60) Provisional application No. 60/218,578, filed on Jul. 17, 2000.
(60) Provisional application No. 60/218,579, filed on Jul. 17, 2000.
(60) Provisional application No. 60/223,814, filed on Aug. 8, 2000.
(60) Provisional application No. 60/236,999, filed on Sep. 29, 2000.
(60) Provisional application No. 60/253,796, filed on Nov. 29, 2000.

(51) Int. Cl. G06F 19/00

(52) U.S. Cl. 701/29

(57) ABSTRACT

The invention disclosed utilizes a computer system that accepts and stores information from subscribers of vehicle communication systems. This information includes information about vehicle drivers, the vehicle and scored data that represents the operational characteristics of the vehicle that has been obtained from vehicle sensors and transmitted through the vehicle communication system. Captured sensor data is processed and presented through a standardized scoring system to protect driver privacy, provide a means for assessing and measuring relative driver safety and to facilitate the offering of insurance discounts by insurance companies. The invention further provides a mechanism for vehicle owners to obtain lower insurance rates based on scored safety-related data and for insurance companies to obtain new insurance subscribers and to provide them insurance discounts based on scored safety-related data.

### FIELD OF THE INVENTION

This invention relates to a method and apparatus for use of vehicle operating data and vehicle communication systems subscriber data to enable more accurate rates, facilitate the purchase of insurance and provide feedback to drivers about their risk exposure.

### BACKGROUND—DESCRIPTION OF THE PRIOR ART

The present invention relates to systems that use operating data from vehicle sensors to price automobile insurance and systems that provide automobile insurance quotations from multiple insurance companies. The present invention overcomes the drawbacks of many current methods for selling automobile insurance, provides data to insurance companies that enables more accurate pricing of insurance premiums, and represents a more efficient, consumer-friendly system for obtaining automobile insurance in an automated fashion.

The automobile insurance industry collects an estimated $119 Billion in annual premiums. Automobile insurance is one of the highest monthly recurring expenses for most consumers. Despite this fact, insurance rates vary widely across insurance companies, geographic areas, vehicle types and other factors that are not necessarily related to the insurance risk of a particular consumer. Consumers are also hesitant to shop around extensively based on the time and inconvenience of obtaining insurance quotations from different insurance companies.

Auto insurers determine who they will insure (termed “underwriting) and what they will charge for their policies (termed “rate setting” or “pricing”) based on the correlation of historical claims payment experiences with the characteristics of particular classes of drivers (termed “actuarial classes”). This estimation process requires extensive data collection and analysis. Some of the primary factors which insurers have been known to utilize in creating actuarial classes include:

Personal Data

Age

Sex

Occupation

Marital Status

Citation History

Accident History

Residence Location

Work Location

Vehicle Data

Manufacturer

Model

Year

Value

Operational Data

Annual miles

Commute Distance

Storage (garage, etc.)

Coverage Desired

Bodily Injury Liability

Comprehensive and Collision

Uninsured motorist liability

Medical Payments

Deductibles

Misc. coverages (towing, rental, etc.)

Rates provided by insurance companies are based on rate plans that describe these actuarial classes. Rates determined by the rate plans may also be adjusted based on discounts offered for various vehicle devices or other factors believed to reduce claim risk, including:

Discounts

ABS

Airbags

Anti-theft devices

Alarm Systems

The selection of data elements to be captured, and how they are used, are not standardized processes in the insurance industry. They vary widely across different insurers who engage in their own actuarial analysis, resulting in creation of proprietary databases and rating systems for determination of underwriting and pricing criteria. Some discounts are mandated by law in certain jurisdictions, while other discounts are offered at the discretion of the insurance company. These discretionary discounts tend to vary in scope and size depending upon the particular insurance company. As a result of the traditional data acquisition, pricing and quotation process, problems arise both for the consumer and the insurers.

One problem with the current insurance process is the extensive amount of information a consumer must submit to an insurance company before they will provide a quotation for coverage. This generally requires the consumer to complete a multi-page questionnaire, spend a significant amount of time on the telephone with a sales representative, or key data into a multi-page online form. This inconvenience represents a barrier that prevents consumers from shopping rates across more insurance companies.

Another problem with the current insurance process is the inaccurate pricing methods employed that are unable to take actual driver operating characteristics into account. Drivers that drive carefully and are safety conscious are lower risk insurance candidates and should be compensated accordingly with lower rates. The current practice of estimating driver risk based on variables such as gender, age, geographic area and vehicle type is not accurate.

Inaccurate pricing also causes problems for insurance companies. Insurance is a highly competitive business, and insurance companies succeed or fail based on the accuracy of their rating and underwriting criteria. When rating and underwriting criteria is inaccurate, profitable customers are turned away because rates are quoted too high and unprofitable customers are accepted based on rates that are too low to cover future claims. Inaccurate pricing also results in regulatory problems for insurers. Insurance is regulated at the State level. States are mandated by the McCann-Ferguson Act to regulate automobile insurance rates to be sure that they are: (1) adequate, (2) not excessive and (3) not unfairly discriminatory. The process of estimating risk based on gender, age, geographic area is inherently a discriminatory process. As a result, automobile insurers are constantly under pressure from insurance regulators and consumer groups to lower rates in a wholesale manner for specific geographic areas or other broad categories of consumers. This may lead to unprofitable writing of business for these categories, and may force rates to be raised in other areas to make up for the loss.

Another problem faced by insurers is the high cost of acquiring insurance subscribers. In an increasingly competitive market, marketing and sales costs are passed on to consumers in the form of higher rates. Insurers must constantly find less costly means to quote and write policies in order to remain competitive.

Another drawback of the present system of pricing and selling automobile insurance is that it does not take advantage of new vehicle-related products and services that could make it easier for consumers to obtain insurance and allow them to receive lower rates. Wireless communication systems, most of which are capable of transmitting data from Global Positioning System (GPS) receivers, necessitate the capture of substantial amounts of subscriber data on the vehicle, its safety features, and the driver. In addition, crash sensors within the vehicle are capable of providing detailed information about a crash. The present system of pricing and selling automobile insurance provides no means of using the subscriber data, the GPS data, crash sensor data or other data that may be wirelessly obtained from the vehicle. Use of this data can allow insurers to more accurately price insurance based on vehicle operating data, enable them to reduce their claims handling costs, and make it easier for consumers to obtain insurance quotations.

The prior art describes some attempts to overcome the above problems, drawbacks and inconveniences. Internet-based insurance agencies are known in the art to sell automobile insurance by providing consumers with multiple insurance offers. While these systems help consumers obtain multiple quotations based on one set of information, these systems have several drawbacks. For a customer to purchase insurance through an internet-based insurance agency, the customer must: (1) find the appropriate web-site; and (2) type-in extensive information about themselves, their vehicle and other information. These services do not offer special discounts to consumers or give them access to special rate plans filed by insurance companies, and none of these systems are known to make use of sensor-obtained vehicle operating data to assist insurance companies in more accurately pricing insurance.

There is only one system known to applicant which utilizes vehicle-obtained sensor data for the pricing of insurance. The system disclosed by McMillan (U.S. Pat. No. 5,797,134 and U.S. Pat. No. 5,926,796) discloses a system for using safety-related data obtained from vehicle sensors to retrospectively make adjustments to an automobile insurance policy for the period in which the safety-related data was obtained. However, this system does place the consumer in control of data obtained from their vehicle, and has several significant drawbacks:

(1) Detailed and specific operating data downloaded from the vehicle infringes on user privacy;

(2) Consumer choice is restricted as there is no means for allowing subscribers to use vehicle operating data to obtain insurance quotations from multiple companies;

(3) Subscribers do not know whether their insurance is likely to be increased or decreased based on the operating data;

(4) McMillan does not provide a means for consumers to obtain quotations in an automated fashion and prevents consumers from obtaining a firm quotation for insurance based on the unknown adjustments that are made at the end of the insurance period.

Thus the present systems for pricing and selling automobile insurance give rise to several problems, inconveniences and drawbacks for consumers, insurance companies, and insurance regulatory agencies. Accordingly, there is therefore a need for a system which can capture information from vehicle communication system subscribers, including safety-related data from vehicle sensors, and enable consumers to provide this information to multiple insurance companies in a manner which: (1) protects driver privacy; (2) provides a standardized means for driver safety to be measured and analyzed for the purpose of determining insurance risk; (3) provides a mechanism allowing insurance companies to provide special insurance rates based on this information or specific insurance discounts; (4) facilitates innovation and competition between insurance companies, and (5) places consumers in control of data obtained from their vehicles, enabling them to use this data to obtain fair insurance rates.

### SUMMARY OF THE INVENTION

In general, a Data Delivery and Processing System (Data D&PS) is disclosed for managing, analyzing and communicating on-board vehicle data to data users, notably insurance companies. In a broad sense, this system acts as a controlled buffer between the consumer and the insurance company with respect to the consumer's vehicle operating data that can be used to provide more accurate rates if shared with the insurance company. This system provides a series of interrelated mechanisms that enable insurance companies to obtain data that enables them to provide more accurate rates while enabling the consumer to provide this data without undesired disclosure of personal information. Objects of the present invention include:

A method and apparatus for presenting information obtained from vehicle communication system subscribers to insurance companies.

A method and apparatus for transmission of safety-related data in a form which protects the privacy of vehicle drivers.

A method and apparatus for presentation of data allowing for comparison of the relative driving safety risks of drivers.

A method and apparatus for measuring and analyzing safety-related vehicle sensor data which allows insurance companies to offer insurance discounts based on historical safety-related data.

A method and apparatus for allowing multiple insurance companies to provide insurance pricing offers and discounts to populations of drivers based on safety-related vehicle sensor data.

A method and apparatus that allows subscriber personal and vehicle information captured as part of a vehicle communications subscription to be used to obtain insurance quotations.

According to one aspect of the invention, a method and apparatus is shown for abstracting on-board vehicle data. On-board vehicle data can contain highly sensitive personal information that consumers do not want recorded, transmitted or otherwise captured where it could potentially be disclosed. Specific operating characteristics of the consumer's vehicle is abstracted on board the vehicle by processing the data into abstract scores using mathematical operations stored in the firmware of the on-board data system. The use of abstract scores enables the data to still be useful to insurance actuaries, and provide the basis for more accurate insurance rates. Abstracted data is transmitted to the Data D&PS where it can be used by the consumer to obtain more accurate insurance rates without compromising privacy.

According to another aspect of the invention, a scoring system is disclosed that enables abstracted data to be used to assess the risk exposure of the consumer. Off-board risk measure information is used to convert abstracted data into scaled scores and safety scores that provide a measure of risk exposure. By enabling a risk exposure assessment, the consumer has gained control of an important piece of information that can be used to obtain a more accurate insurance rate from an insurance company. The disclosed scoring system also gives the insurance company a high level of control regarding how the scaled scores and safety scores are calculated.

According to another aspect of the invention, consumers may be provided the scoring system information prior to transmission to insurance companies in order to understand their risk exposure and their prospects for obtaining insurance discounts.

According to another aspect of the invention, consumers are provided a mechanism for saving insurance companies additional cost by providing them crash sensor data immediately after being involved in a crash. By receiving detailed crash information immediately after an insured has been in a crash, insurance companies reduce their claims costs, savings that can be passed on to the consumers providing the information in the form of reduced premiums.

A more complete understanding of the present invention, as well as well as further features and advantages of the present invention, will be obtained by reference to the following detailed description, drawings and appended claims. The descriptions in this application are explanatory only and are intended to provide further explanation of the invention.

### DRAWINGS AND FIGURES

FIG. 1 is a bock diagram showing an overview of the overall system.

FIG. 2 is a vehicle-level block diagram illustrating an on-board data system.

FIG. 3 is a flowchart illustrating a process for scoring and transmitting data from a vehicle.

FIG. 4 is an exemplary document requesting subscriber authorization to monitor and transmit data from the vehicle.

FIG. 5 is a flowchart illustrating a process for programming an on-board data system.

FIG. 6 is a flowchart illustrating a process for generating abstract scores from an on-board data system.

FIG. 7a is a diagram of an exemplary multi-point abstract score calculation for spatial data.

FIG. 7b is a diagram of an exemplary multi-point abstract score calculation for driving time data.

FIG. 8 is a diagram showing data inputs and outputs to a data delivery and processing system.

FIG. 9a is a schematic block diagram of an exemplary data management system.

FIG. 9b is a diagram showing data inputs and outputs to a safety subscriber database and an active lead database.

FIG. 10 is a schematic block diagram of an exemplary data analysis system.

FIG. 11 is a schematic block diagram of an exemplary safety data presentation system.

FIG. 12a is an exemplary diagram of a scaling algorithm

FIG. 12b is a flowchart illustrating a process for generating a scaled score from a single-point abstract score

FIG. 12c is an exemplary database of scaled scores

FIG. 13a is a flowchart illustrating a process for generating a scaled score from a multi-point abstract score

FIG. 13b is a diagram that illustrates the use of a risk measure database in calculating a scaled score

FIG. 14a is a flowchart illustrating a process for generating an overall safety score from scaled scores

FIG. 14b is an exemplary database of weighting factors

FIG. 14c is an exemplary calculation of an overall safety score using scaled scores and weighting factors

FIG. 15a is an exemplary database of historical safety scores

FIG. 15b is an exemplary database of contact information for subscribers

FIG. 16a is an illustrative chart of scaled scores for a particular period

FIG. 16b is an illustrative chart of historical scores for multiple periods

FIG. 17 is an illustration of a user interface used to access score data

FIG. 18 is a block diagram of an expert system for analyzing scoring data

FIG. 19 is a flowchart illustrating a process for providing insurance quotations

FIG. 20 illustrates an exemplary subscriber authorization request

FIG. 21 illustrates an exemplary quote data form

FIG. 22 illustrates an exemplary subscriber data confirmation form

FIG. 23 is an exemplary active lead database

FIG. 24 is a block diagram showing the use of query engines

FIG. 25 is an exemplary block diagram showing the data inputs and outputs to an exemplary insurance company computer system

FIG. 26 is a schematic block diagram of an exemplary quotation management system

FIG. 27 is a schematic block diagram of an exemplary discount analysis system

FIG. 28 is a schematic block diagram of an exemplary policy management system

FIG. 29a is an exemplary login screen

FIG. 29b is an exemplary input form for insurance company weighting factors

FIG. 30a is a chart depicting an exemplary relationship between safety score and insurance risk reduction

FIG. 30b is an exemplary database discount table

FIG. 31 is a flowchart illustrating a process for transmitting quotations by an insurance company

FIG. 32 is an exemplary database of query analysis results that an insurance company might see based on its query activity of the active lead database

FIG. 33 is an exemplary quotation communication linking a subscriber to a web address

FIG. 34 is an exemplary reporting database of aggregate data to insurance companies

FIG. 35a is an exemplary collision rating table

FIG. 35b is an exemplary liability rating table

FIG. 36 is a flowchart illustrating a process for rate quoting

FIG. 37 is a flowchart illustrating a process for limiting the use of the system

FIG. 38 is an exemplary quotation request form

FIG. 39 is a flowchart illustrating a process for requesting quotations

### DETAILED DESCRIPTION OF THE INVENTION

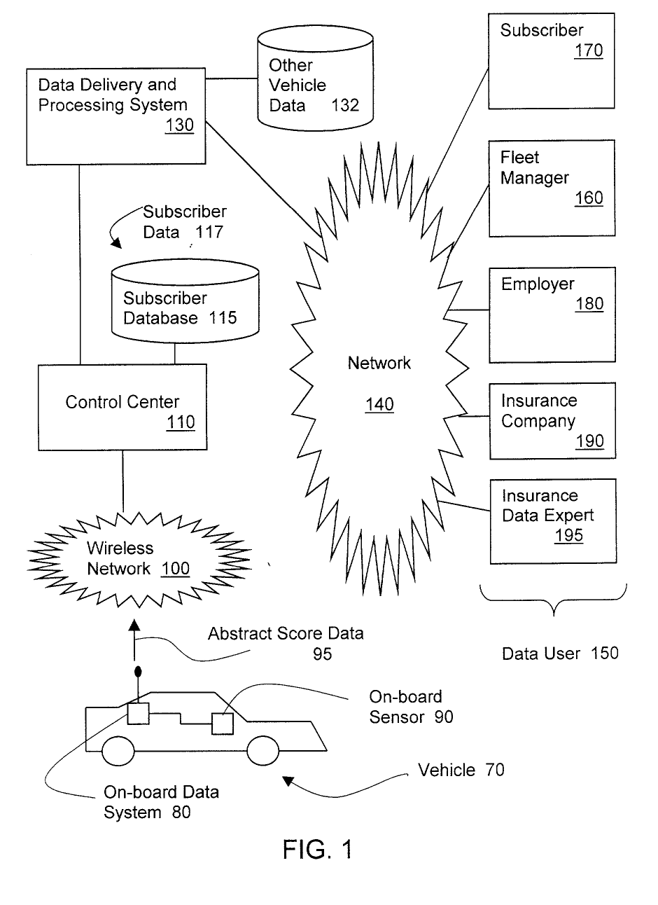

FIG. 1 shows a broad overview of the system. From a data-flow perspective, on-board vehicle data is generated by On-board Sensors 90 shown within a Vehicle 70, which could be any type of motor vehicle including a passenger automobile or truck. On-board vehicle data includes data that is representative of specific operating characteristics of the vehicle, including but not limited to data about speeds, vehicle locations, time of operation, amount of use, braking and turn signal activity, and any other information that may be generated by On-board Sensors 90 that may be useful in assessing the risk exposure for the driver and the vehicle. This information may also be used to assess the driving characteristics of a particular driver of the vehicle.

The On-board vehicle data is then processed by the On-Board Data System 80 into Abstract Score Data 95. Abstract Score Data 95 is vehicle operating data that has been abstracted by being processed through a mathematical algorithm into one or more abstract scores that are free of specific vehicle operating data. The abstracting process of transforming on-board vehicle data into Abstract Score Data 95 is designed to protect the privacy of drivers who desire to have information captured that reflects their risk exposure but do not want to disclose particulars about where, when and how they drive their vehicle.

On-board Data System 80 is shown as a passenger vehicle voice and data communications system, and could be any type of wireless communications system capable of transmitting data. Telematics systems such as the General Motors OnStar system or the Mercedes Benz Tele-Aid systems are examples of On-board Data Systems. On-board Data System 80 is further shown connected to a Wireless Network 100 that could be any wireless network, including a cellular telephone network, paging network, satellite communications network, local radio network or other wireless network commonly used as a communication system for wireless data and/or voice.

After it is processed within the On-board Data System 80, Abstract Score Data 95 may be wirelessly transmitted through a Wireless Network 100. The Abstract Score Data 95 is received by a Control Center 110 in a remote location. The Control Center 110 is an operations center configured to receive data from On-board Data System 80 including a provider of subscription-based emergency services to vehicle communication system subscribers (such as General Motors' OnStar service), a provider of messaging or location-tracking services to commercial vehicles, or a Public Safety Answering Point (PSAP). The control center 110 preferably includes a Subscriber Database 115 which contains Subscriber Data 117, including information about the individuals and vehicles being provided services by the Control Center 110. Subscriber Data 117 may include data elements such as:

Personal Data

Primary Driver Name

Primary Driver Description

Secondary Driver Names

Secondary Driver Descriptions

Spouse Name

Driver Address

Driver Phone Number

Driver License Number

Date of Birth

Social Security Number

Credit Card Number

Special Medical Conditions

Medication Allergies

Emergency Contact Names, Relationships and Numbers

Vehicle Data

Vehicle Make

Vehicle Model

Vehicle Year

Vehicle Body Style

Vehicle Identification Number (VIN)

Name of Lienholder

Address of Lienholder

Telephone Number of Lienholder

Name of Lessor

Address of Lessor

Telephone Number of Lessor

Vehicle Safety Equipment

The Control Center 110 is connected to the Data Delivery and Processing System 130 (“Data D&PS”). These facilities may be connected by a local network if located in the same facility, or may be connected by the internet or other wide area network if located in different geographic areas. The Data D&PS 130 represents one or more computer systems configured to accept and process Abstract Score Data 95 sent by an On-board Data System 80, and preferably Subscriber Data 117 from the Subscriber Information Database 115. One of the primary functions of the Data D&PS 130 is to enable vehicle owners to make use of this data to analyze their risk exposure or to provide information to insurance companies that may enable more accurate insurance rates to be provided.

The Data D&PS 130 makes this data accessible for analysis and use through the Network 140 by storing it in a central database. This information may be used by Insurance Companies 190 to provide policy quotations without consumers having to key-in information which is already stored in a Subscriber Information Database 115. Other Vehicle Data 132 may also be accepted by the Data D&PS 130 which may include additional information of use to Insurance Companies 190 to provide policy quotations, thereby preventing data key-in by consumers. Other Vehicle Data 132 may include information from a vehicle finance database, vehicle purchase database, crash test database or a vehicle equipment database. These databases may include information about the safety equipment on a particular vehicle, the performance of the vehicle in crash testing, and the credit of the vehicle purchaser.

The Data D&PS 130 is preferably located within a secure structure designed to withstand power outages and natural disasters. The Data D&PS 130 performs functions such as: (1) analyzing and scoring Abstract Score Data 95 to determine the safety risk of a particular subscriber or vehicle; (2) providing a mechanism for subscribers to obtain automobile insurance quotes from insurance companies; and (3) providing a mechanism for insurance companies to provide insurance quotes to a population of vehicle communication system subscribers. The Data D&PS 130 is connected to a Network 140 which allows multiple Data Users 150 to access and analyze data, including Insurance Companies 190, Insurance Data Experts 195, Subscribers 170, Fleet Managers 160 and Employers 180.

Subscribers 170 are individuals that drive, own, operate or are otherwise concerned with a particular vehicle that serviced by a vehicle communication system. Fleet Managers 160 are individuals or entities that have responsibility for a fleet of vehicles maintained by an organization. Employers 180 are entities or individuals that employ individuals driving vehicles that are serviced by a vehicle communication system. Insurance Data Experts 195 preferably include individuals trained in the area of automobile-related property/casualty risk 195. Insurance Data Experts 195 may provide assistance to other Data Users 150, such as data interpretation and analysis, evaluation of underwriting opportunities, and evaluation of Abstract Score Data 95. Insurance Data Experts 195 may create algorithms to process sensor data and scored data, and may construct or analyze databases that relate risk to sensor data or scored data. Insurance Companies 190 may be any insurance company, including in particular those insurance companies involved in providing property casualty insurance.

The Network 140 preferably includes connection to the internet, or other wide area network which allows access to the Data D&PS 130 by Data Users 150 located in different geographic areas, including Insurance Companies 190, Subscribers 170, Employers 180 and Fleet Managers 160 which may be located remotely. Access by Insurance companies 190 allows Insurance Companies 190 to provide quotes to subscribers or query a database of Subscribers 170 looking for lower insurance rates.

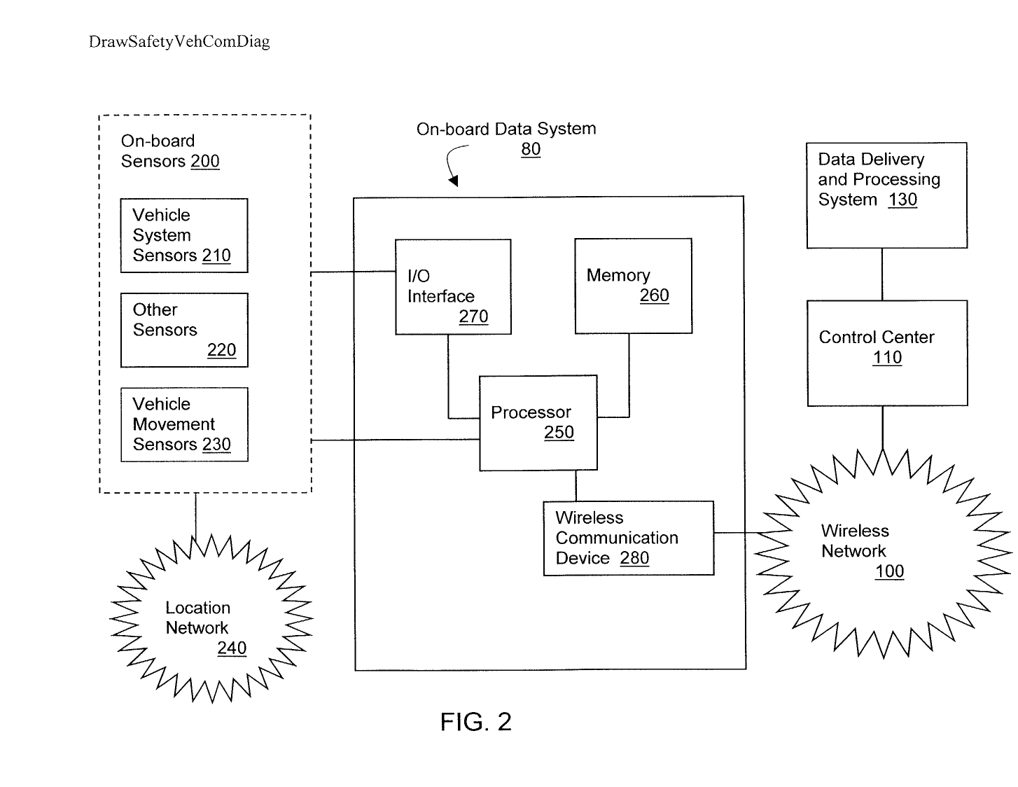

FIG. 2 shows a vehicle level block diagram of an On-board Data System 80 exemplary of a passenger vehicle communications system. On-board Sensors 200 which may provide on-board vehicle data to the On-board Data System 80 may be any type of vehicle sensors capable of providing information regarding the risk-related operational characteristics of a vehicle, including Vehicle System Sensors 210, Vehicle Movement Sensors 230 and Other Sensors 220 capable of detecting information about the operating characteristics of a motor vehicle.

Vehicle Movement Sensors 230 may include a location device such as a Global Positioning System (GPS) receiver, and could be any Radio Frequency (RF) device used to determine location through location-determination methods commonly known in the art including but not limited to Time Distance of Arrival, Angle of Arrival, wireless-assisted GPS, RF Fingerprinting and Loran. Location Network 240 is preferably the network of satellites which comprise the GPS System, and could represent a network used for one of the aforementioned location-determination methods or an advanced cellular network capable of determining the location of cellular transceivers. Vehicle System Sensors 210 may include any sensor that detects the operation or non-operation of a vehicle component such as the brakes, turn signals, seat belts, transmission, engine, ABS or ignition. Other Sensors 220 may include collision avoidance sensors, lane departure sensors, crash sensors capable of detecting when the vehicle has been in a collision, and crash sensors capable of providing information about the forces of the collision sustained by the vehicle and its occupants. This application incorporates by reference co-pending patent application entitled “System and Method for Delivering Crash Information,” by John Burge, a U.S. Provisional Patent Application filed on Sep. 29, 2000. Data generated by crash sensors, including data described in the above-referenced co-pending patent application, are also referred to herein as crash data. Additional sensors developed in the future which provide on-board vehicle data should be considered as falling within the scope of the present invention.

These On-board Sensors 200 may capture on-board vehicle data including:

Sampled Data

Vehicle Speed

Miles Driven

Driving Time

Time of day

Geographic Location

Rates of acceleration and deceleration

Covered Storage Activity and Location

Seatbelt Use

Engine Speed

Wheel Speed

Transmission Status

Event-Generated Data

Automatic Collision Notification

Airbag Activation

Crash avoidance sensor activation

Lane departure sensor activation

Ignition activation

Transmission shifts

Safety equipment use (seat belts, brakes, turn signals)

On-board vehicle data may be captured from On-Board Sensors 90 in a variety of ways, including a pre-established sampling frequency, random sampling frequency, periodic sampling or a sample that results from the occurrence of an event. On-board vehicle data is abstracted into Abstract Scores 800 which are then stored within the On-Board Data System 90. The purpose of Abstract Scores 800 are to provide generalized information about the operating characteristics of a vehicle in order to assess the safety of the vehicle operation while simultaneously protecting the privacy of the vehicle operator by preventing disclosure of specific operating characteristics of the vehicle. The process of converting on-board vehicle data obtained from On-Board Sensors 90 represents a privatizing or abstracting of the data. In order to prevent disclosure of specific operating characteristics of the vehicle, data captured from On-Board Sensors 90 is abstracted or privatized into Abstract Scores 800 within the On-Board Data System 90. Sensor data for each specific operating characteristic monitored is consolidated into an Abstract Score 800 for that specific operating characteristic using mathematical processing through a scoring algorithm. The scoring algorithm may represent any form of mathematical processing for consolidated representation of data values known in the art, including averaging, summing, totaling, as well as calculation of standard deviations, means and medians or other mathematical technique for representing multiple data points as consolidated values, value ranges or scores. The resulting Abstract Scores 800 should be free of specific operating characteristics of the vehicle, and not disclose a specific time, speed, location or other specific data regarding the operating activities of the vehicle from which the data was obtained. Abstract Scores 800 may include, but are not limited to:

Average Speed

Total Miles Driven

Total Driving Time

Time-of-day Driving Profile

Geographic Driving Area Profile

Acceleration/Deceleration profile

Crash Avoidance Sensor Activations/mile

Lane Departure Sensor Activations/mile

Safety Equipment Use Profile

Total Ignition Activations

Transmission Shifting Profile

The On-board Data System 80 in FIG. 2 is shown as a computer containing a Processor 250, I/O Interface 270, and Memory 260. It is also shown with a Wireless Communications Device 280. The Wireless Communications Device may be any wireless device known in the art to be capable of transmitting data across a Wireless Network 100, including a wireless modem, cellular telephone, pager, radio or satellite terminal. The Wireless Communication Device 280 is preferably a digital or analog cellular radio and the Wireless Network 100 is preferably the digital or analog cellular radio system. Cellular radios and networks are commonly used in today's vehicle communication systems such as General Motors OnStar and Mercedes Tele-Aid.

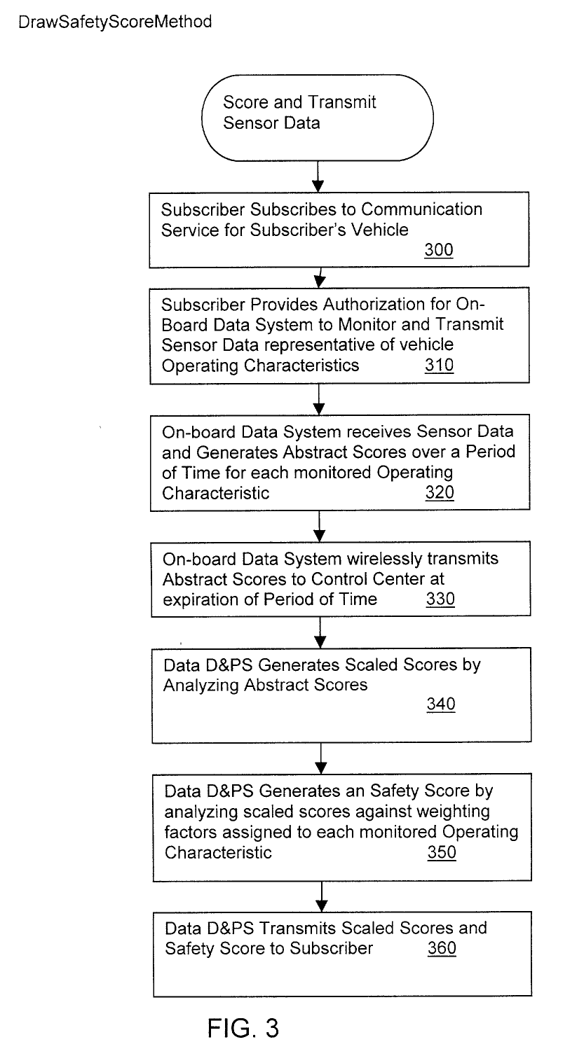

FIG. 3 is a flowchart illustrating a process for scoring and transmitting Abstract Score Data 95 from an On-Board Data System 90. In step 300 a subscriber signs up for a vehicle communication service. This may be any type of vehicle communication service in which equipment is placed in the vehicle that is capable of wirelessly transmitting data. In step 310, the subscriber authorizes vehicle operating characteristics to be monitored by the sampling and transmission of on-board vehicle data. This may be accomplished by the subscriber replying to an email or mailer, or replying to any reliable form of communication requesting authorization. This may also be accomplished by the Subscriber providing authorization at the time they sign up for their vehicle communication system service. In step 320, abstract scores are generated for a period of time by the On-Board Data System 90. The period of time, and the specific vehicle operating characteristics to be monitored are chosen in advance. In step 330, the On-Board Data System 90 wirelessly transmits Abstract Score Data 95 contained within the On-Board Data System 90. In step 340, the Data D&PS 130 generates Scaled Scores 860 from the Abstract Scores 800. In step 350, a Safety Score 870 is generated by the DD&PS 130 by analyzing the Scaled Scores 860 against a set of Weighting Factors 1435. The Weighting Factors 1435 take into account the overall impact on safety of each Scaled Score 860 in comparison to the other Scaled Scores 860, resulting in a Safety Score 870 that is an accurate representation of the relative safety of the driving habits of a particular Subscriber 170. In step 360, the Scaled Scores 860 and Safety Score 870 are transmitted to the Subscriber 170 so they may evaluate the safety of their driving habits.

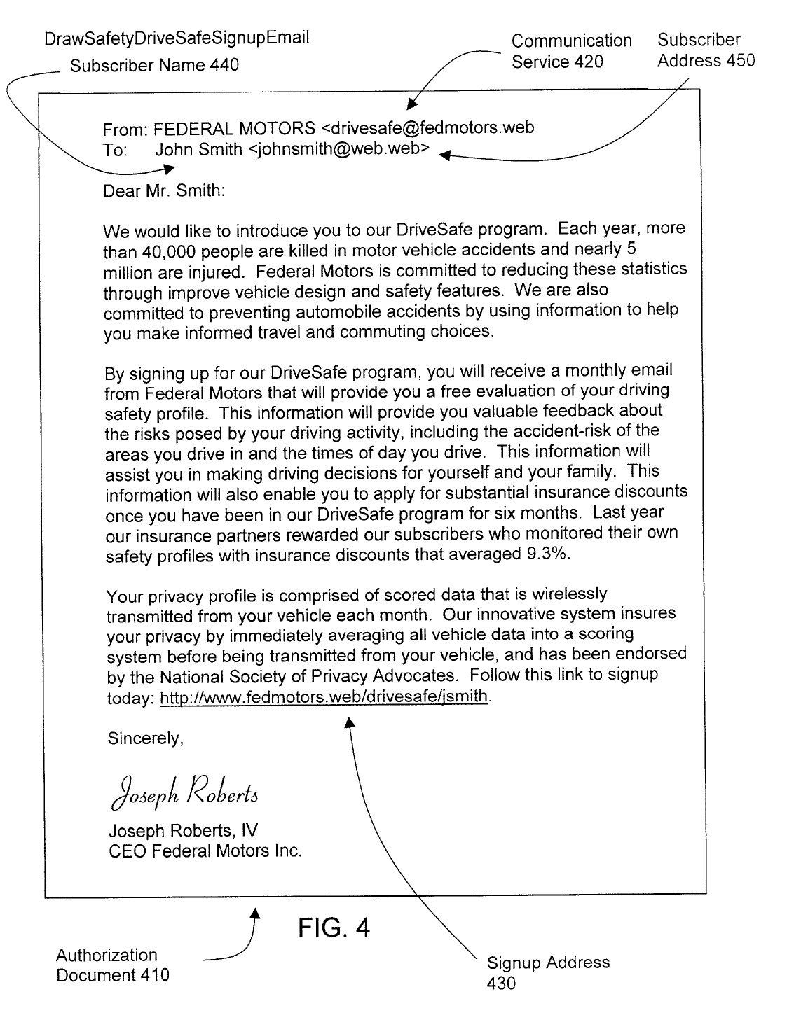

FIG. 4 is an exemplary Authorization Document 410 requesting subscriber authorization to monitor and transmit data from the vehicle, shown here in the form of an email. The Communication Service 420 indicates the provider of the vehicle communication service from which the subscriber receives service. The Subscriber Name 440 and Subscriber Address 450, shown here as an email address, may be obtained from the Subscriber Database 115 and are preferably captured when the Subscriber 170 signs up for their vehicle communication service. A Signup Address 430 is shown, here in the form of a website link contained within the email, allowing the Subscriber 440 to authorize the monitoring and transmission of data by completing an electronic form located on a network at the location of the Signup Address 430. The Authorization Document 410 could also be a paper document mailed to the Subscriber 170 after they signed up for their vehicle communication service, or could be a document presented to the Subscriber 170 at the time they sign up for their vehicle communication service, either as part of the paperwork involved in signing up for the vehicle communication service or a separate document.

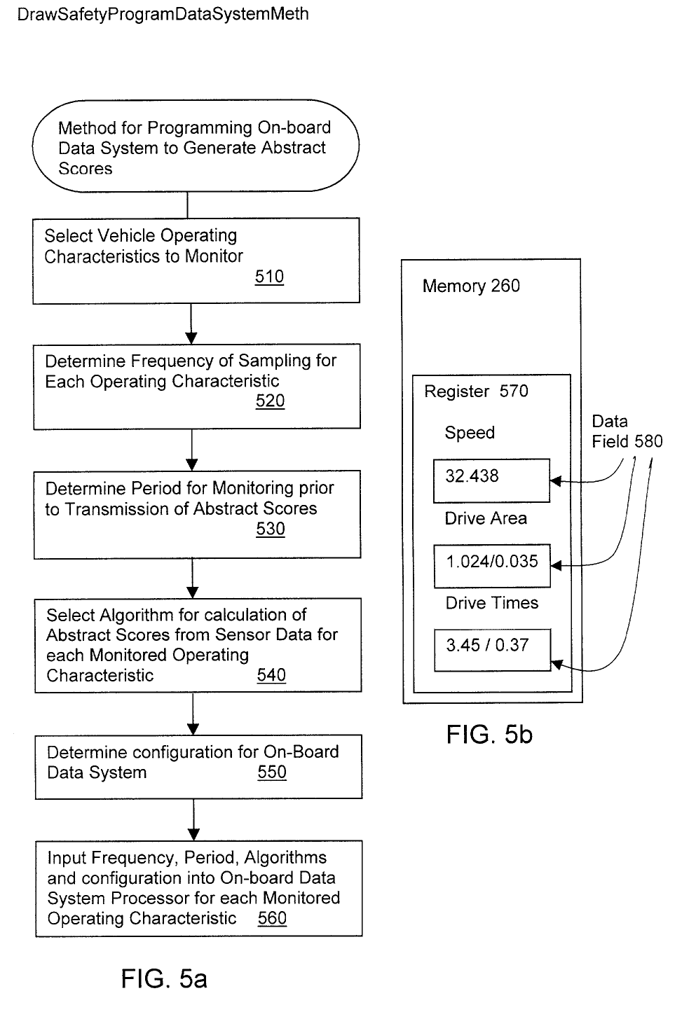

FIG. 5a is a flowchart illustrating a process for programming an On-Board Data System 80 to generate abstract scores. In step 510 the specific vehicle operating characteristics to be monitored are selected. These may be selected based on the type of On-Board Sensors 200 available in a particular vehicle model or in a particular type of vehicle communication system. They may also be selected based on the importance of a vehicle operating characteristic to the safety of the vehicle operator or evaluation of insurance risk. In step 520, the sampling frequency for each vehicle operating characteristic is selected. Sampling frequency may vary depending on the accuracy of the information required to evaluate driver and operating behavior. In step 530, the time period is selected for calculation of abstract scores prior to transmission from the vehicle. The time period may be established based on weighing the cost to transmit the data against the need for Data Users 150 to view current data. In step 540 an algorithm is selected to generate Abstract Scores 800 from each vehicle operating characteristic that is monitored. In step 550, a configuration is determined for the On-Board Data System 80, including configuration of a Register 570 in the Memory 260 of the On-Board Data System 80. In step 560 the preceding selections and configurations are input into the On-Board Data System 80 to enable it to calculate, store and transmit the abstract scores. Steps 510-550 may occur in any order, or all at once. Step 560 may occur during production of the vehicle communication system, production of the vehicle, may represent a data download post-production, or may represent a wireless download of software to an On-Board Data System in a vehicle that is currently on the road.

FIG. 5b is a diagram of a Register 570 within the Memory 260 of the On-Board Data System 80. Abstract Scores 800 populate the Data Fields 580 of the Register 570 for each operating characteristic sought to be measured, and are updated by the scoring algorithm as new samples of on-board vehicle data are captured. In some circumstances when a period ends and Abstract Scores 800 have been transmitted, it may be desireable to insure that recently vacated Data Fields 580 do not take on the specific value of the first sensor sample of a new period. One way to prevent this is by using a dummy sensor sample that is based on either the value of a transmitted Abstract Score 800 or value falling within the range of a transmitted Abstract Score 800. At or near the time of wireless transmission of the Abstract Scores 800, the Abstract Scores can be used to generate dummy sensor samples that populate the Data Fields 580. The dummy sensor sample will then enable the first sensor sample of the new period to create a new Abstract Score 800 without placing the specific value of the new sensor sample in the Data Field 580. This would provide an added measure of privacy protection should anyone attempt to extract data from the vehicle to determine the vehicle operating activities after the first sensor sample of a new period.

Abstract Scores 800 may be single-point or multi-point Abstract Scores 800 depending on the detail needed for the operating characteristic and the complexity of the Abstract Score 800 that can be attained without disclosing specific vehicle operating activities or triggering undue privacy concerns. Some operating characteristics may be expressed easily as a single-point Abstract Score 800 such as Total Miles 1470 or Total Time 1480. Other operating characteristics may require expression as multi-point Abstract Scores 800 in order to provide sufficient data for safety and insurance use. For example, Drive Area 1450 may need to provide sufficient information about the geographic areas that a vehicle has traveled in order to determine the most common zip codes encountered as well as determine general information about the territory of home and work locations and estimated commute distances for the purposes of providing verified information to insurance companies about these rating factors. Risk measure data regarding the risk posed by geographic area of travel (commonly referred to as a rating “territory” in the insurance industry) is commonly determined based on the zip code of the travel area. A single-point representation of this data, such as an average location, may be insufficient to determine the zip codes with a reasonable degree of accuracy. As a result, a multi-point representation may need to be generated by the scoring algorithm.

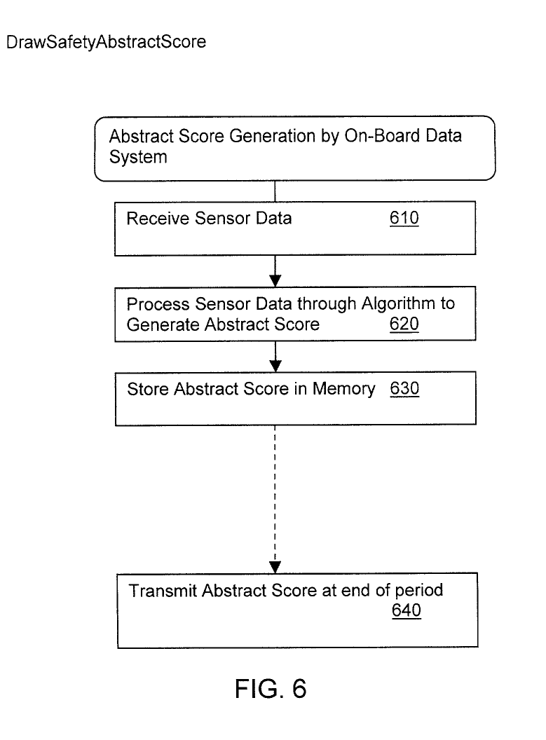

FIG. 6 is a flowchart illustrating the process of an On-Board Data System 80 generating an Abstract Score 800 for a particular operating characteristic. In step 610 an On-Board Data System 80 receives data sampled from an On-Board Sensor 200 that measures the particular operating characteristic. In step 620 the On-Board Data System 80 processes the sampled sensor data through a scoring algorithm. If an existing Abstract Score 800 for the particular operating characteristic calculated earlier in the period is currently being stored in the Memory 260 of the On-Board Data System 80, it is updated by the scoring algorithm based on the sampled sensor data. In step 630 the Abstract Score 800 is then stored in Memory 260 until another sample of sensor data is received. In step 640, the current Abstract Score 800 is transmitted when the period expires.

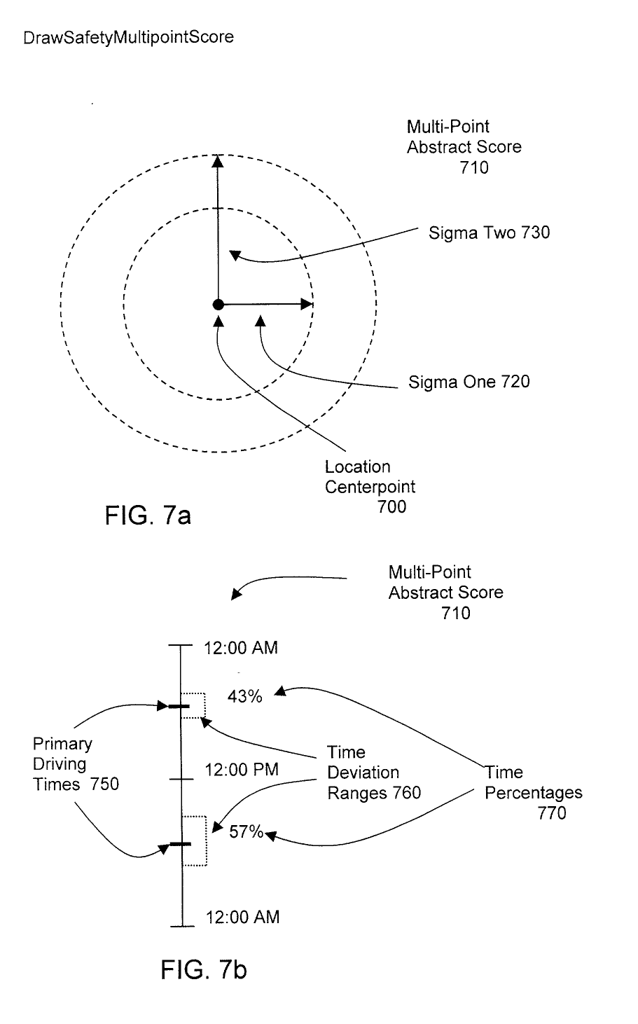

FIG. 7a is a graphical illustration of an exemplary Multi-Point Abstract Score 710 calculated by a scoring algorithm, here showing the primary geographic areas that a particular driver travels within. Multi-Point Abstract Score 710 is shown here as including a Location Centerpoint 700 expressed in GPS latitude and longitude coordinates. Location Centerpoint 700 is shown here as representing an average of all vehicle location readings obtained during the period. Location Centerpoint 700 could be a median, or could represent multiple centerpoints based on clusters of geographic area driving activity. Deviations from the Location Centerpoint 700 are shown expressed as radii Sigma One 720 and Sigma Two 730, which could be any mathematical representation of deviation from the Location Centerpoint, including standard deviation calculations. While Radii Sigma One 720 and Sigma Two 730 are shown as defining concentric circles around Location Centerpoint 720, they could also represent a square area of driving activity or could be calculated to define an oval or rectangular area of driving activity.

FIG. 7b is a graphical illustration of another exemplary Multi-Point Abstract Score 740 calculated by a scoring algorithm, here shown as a driving time chart. Primary Driving Times 750 are shown as averages of morning and afternoon driving times, and could be used to show whether a vehicle is being operated during high-risk driving times or low-risk driving times. Time Deviation Ranges 760 from Primary Driving Times 750 are shown along with Time Percentages 770 which represent a percentage of time during which driving activity takes place within the Time Deviation Ranges 760. Time Deviation Ranges 760 could be any mathematical representation of deviation from Primary Driving Times 750, including standard deviation calculations.

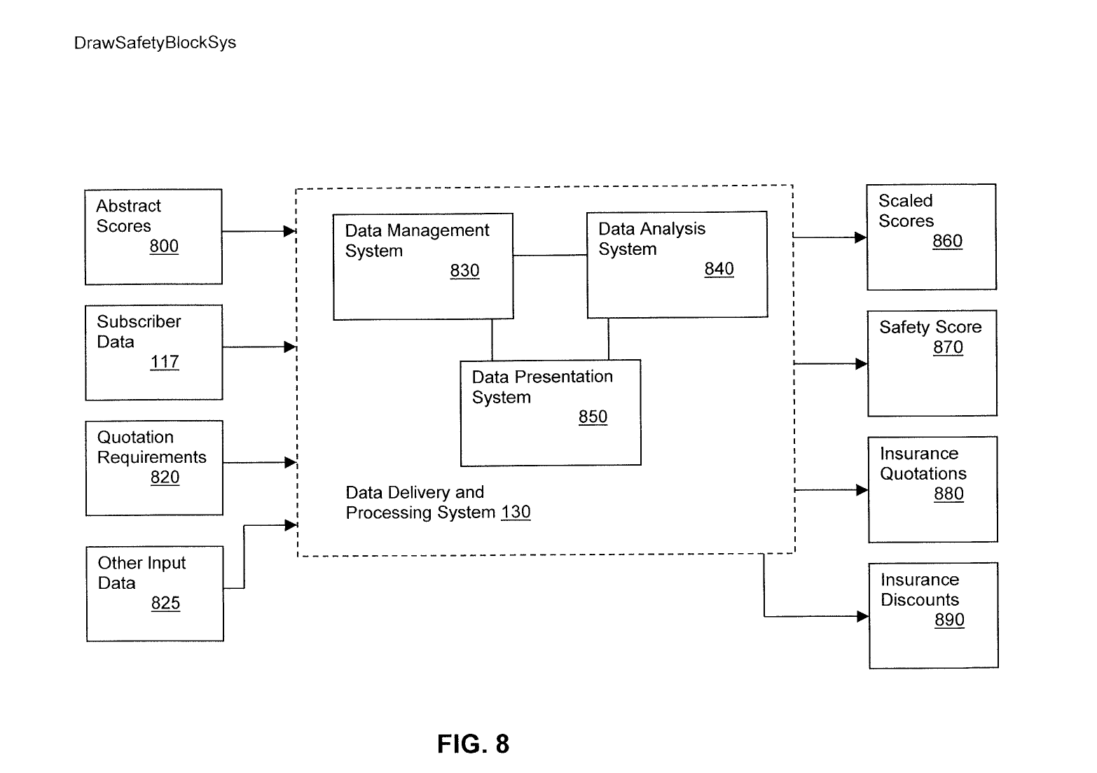

FIG. 8 is an overview bock diagram of a Data Delivery and Processing System 130 including data inputs and outputs. The Data Delivery and Processing System 130 is shown as including a Data Management System 830, Data Analysis System 840 and Data Presentation System 850. The Data Management System 830 is configured to receive Subscriber Data 117, Abstract Scores 800, Quotation Requirements 820 and Other Input Data 825. The Data Analysis System 830 is configured to analyze this data and to generate Scaled Scores 860, Safety Scores 870 and Insurance Quotations 880. The Data Presentation System 850 is configured to display data to Data Users 150 and manage the input of data from Data Users 150 into the Data Delivery and Processing System 130.

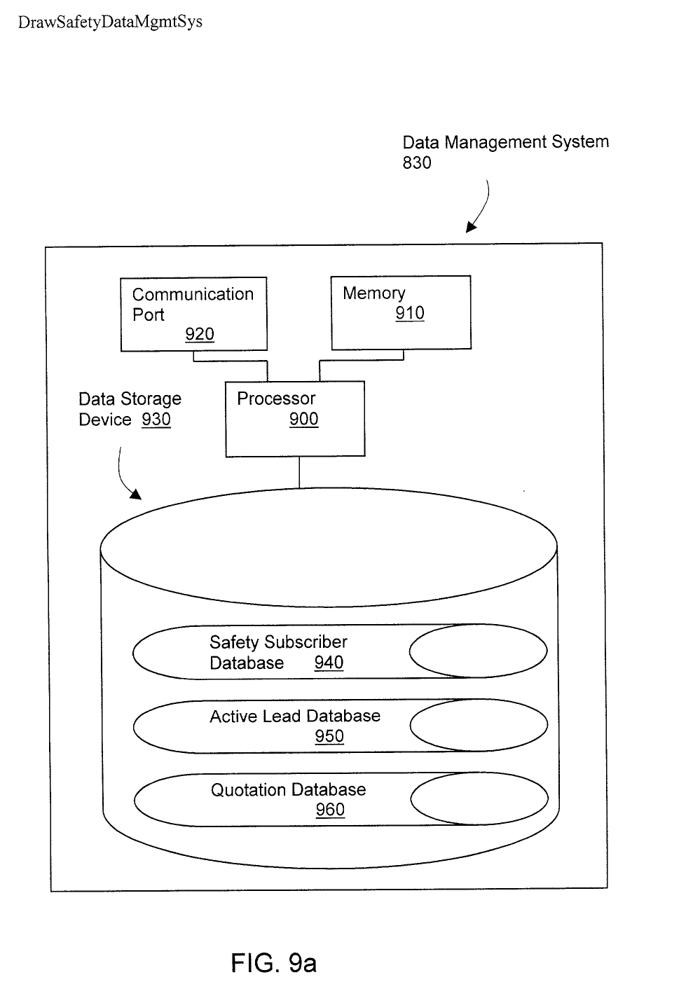

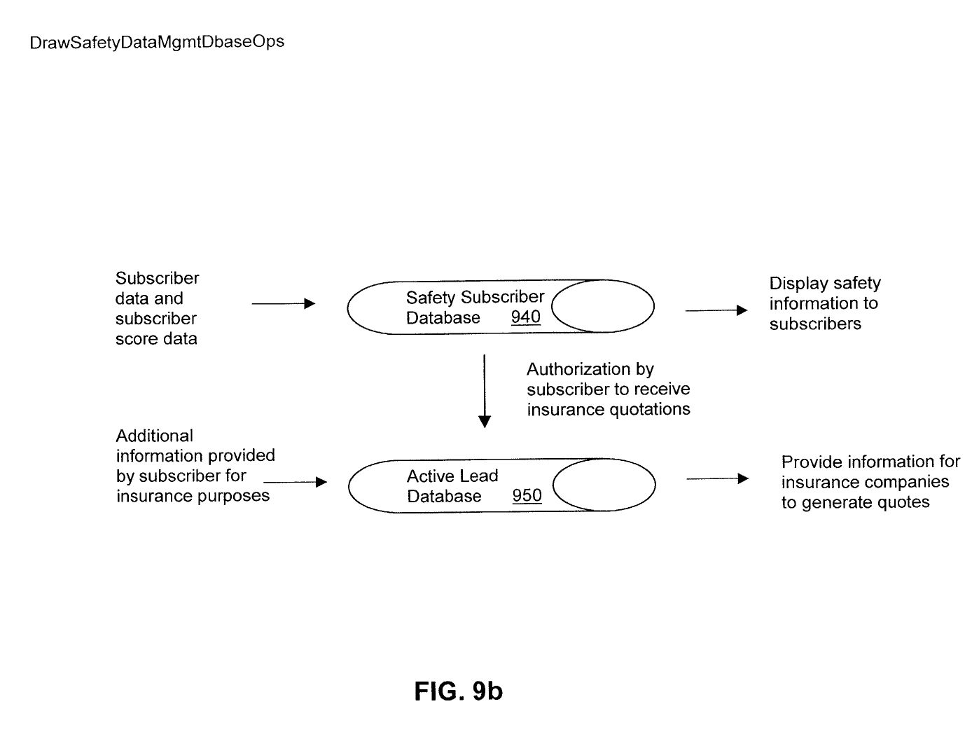

FIG. 9a depicts a block diagram of a Data Management System 830, shown as a central database server. The Data Storage Device 930 is shown which may contain a variety of databases, including Safety Subscriber Database 940, Active Lead Database 950 and Quotation Database 960. The Data Management System 830 includes a Processor 900, Communication Port 920, and Memory 910 for managing the operations of the Data Management System 830, including: (1) inputting of new Abstract Score Data; (2) inputting of new subscriber data; (3) management of Data User 150 access; (4) management of subscriber insurance requirements information; (5) database searches and queries for data analysis by Data Users 150; (6) management of insurance quotations and denials. FIG. 9b is an overview diagram of the relationship between the Safety Subscriber Database 940 and the Active Lead Database 950. The purpose of the Safety Subscriber Database 940 is for storage of Subscriber Data 117 and scoring data used to provide Subscribers 170 feedback regarding the safety of their vehicle operating characteristics, and is primarily used by Subscribers 170. The purpose of the Active Lead Database 950 is for Subscribers 170 to receive insurance quotations, and is primarily used by Insurance Companies 190 querying the database with their rating and underwriting criteria or for marketing purposes to specifically request insurance quotations from insurance companies on behalf of individual subscribers.

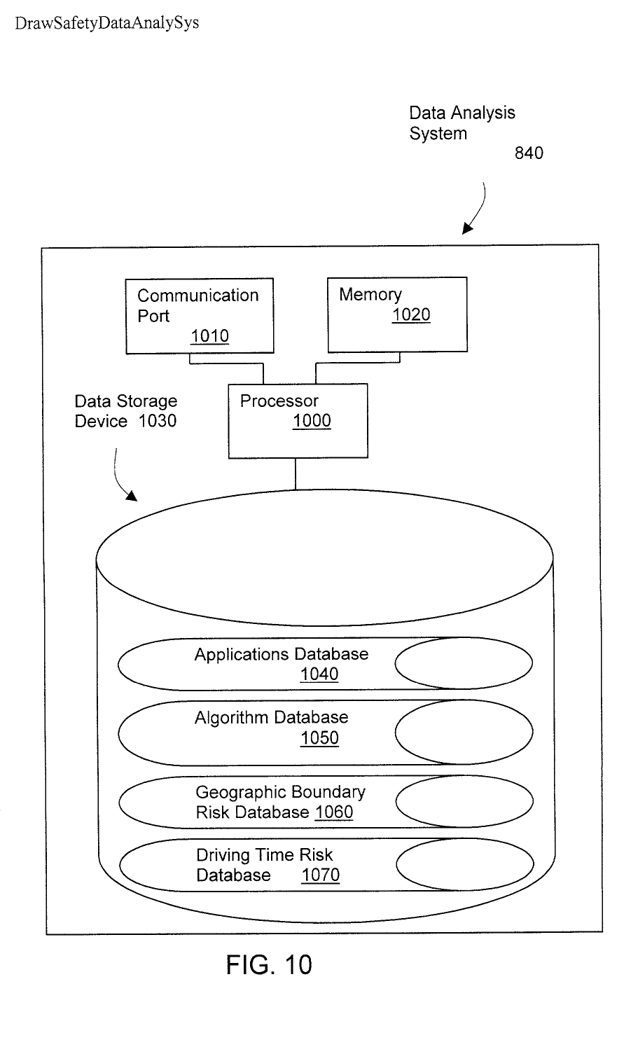

FIG. 10 depicts a block diagram of a Data Analysis System 840, shown as a central applications server. The Data Analysis System 840 is used to generate Scaled Scores 860 and Safety Scores 870 for display to Subscribers 170 and other Data Users 150 through the Data Presentation System 850, and may also be utilized by Insurance Companies 190 and other Data Users 150 for analysis of Abstract Scores 800, Subscriber Data 117 and Quotation Requirements 820. The Data Analysis System 840 includes a Processor 1000, Communication Port 1010, and Memory 1020 for managing the operations of the Data Analysis System 840, which may include: (1) Calculating scaled scores from abstract scores; (2) calculating Safety Scores from Scaled Scores and various weighting factors; (3) calculating algorithms relating Abstract Scores to Risk Measures; (4) calculating Weighting Factors relating Scaled Scores to Safety Scores; and (5) Calculating Insurance Discount Information. A Data Storage Device 1030 is also shown which may contain a variety of databases utilized by the Data Analysis System 840, including an Applications Database 1040, an Algorithm Database 1050, and databases that contain risk measure information that may be used to correlate Abstract Score data to safety and risk, here shown as examples are a Geographic Boundary Risk Database 1060 and a Driving Time Risk Database 1070.

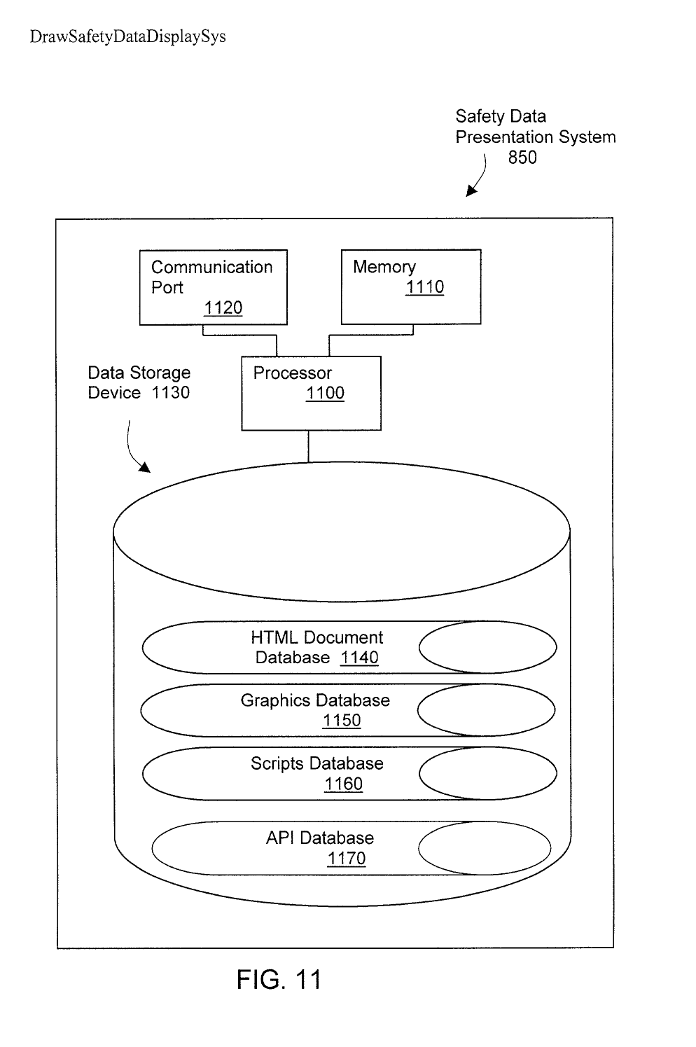

FIG. 11 depicts a bock diagram of a Data Presentation System 850, shown as a central web server. The Data Presentation System 850 includes a Processor 1100, Communication Port 1120, and Memory 1110 for managing the operations of the Data Presentation System 850, which may include: (1) Displaying Scaled Scores and Safety Scores to Data Users 150, particularly Subscribers 170; (2) Managing network inputs of data in coordination with the Data Management System 830; (3) managing subscriber 170 insurance quote requests; (4) Managing query requests by Data Users 150, particularly Insurance Companies 190 querying the Active Lead Database 950; (5) Managing Data User 150 access requests; and (6) presenting insurance quotation information to Subscribers. The Data Storage Device 1130 is also shown which may contain a variety of databases, including an HTML Document Database 1140, a Graphics Database 1150, a Scripts Database 1160 and an API Database 1170.

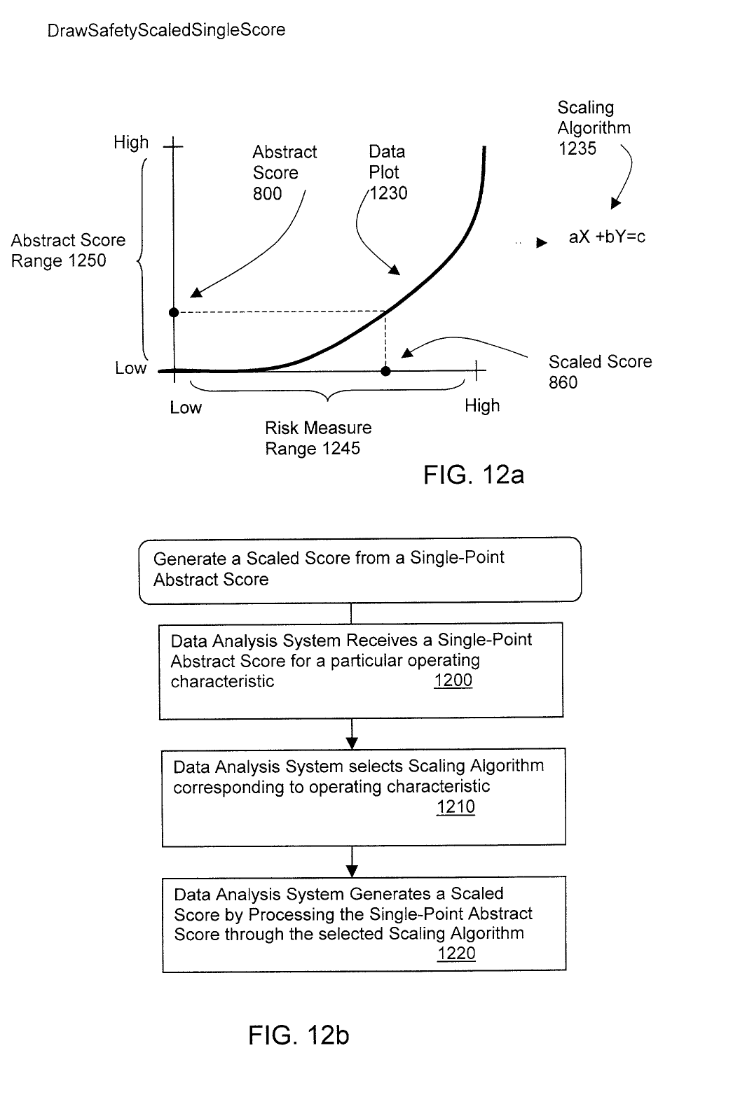

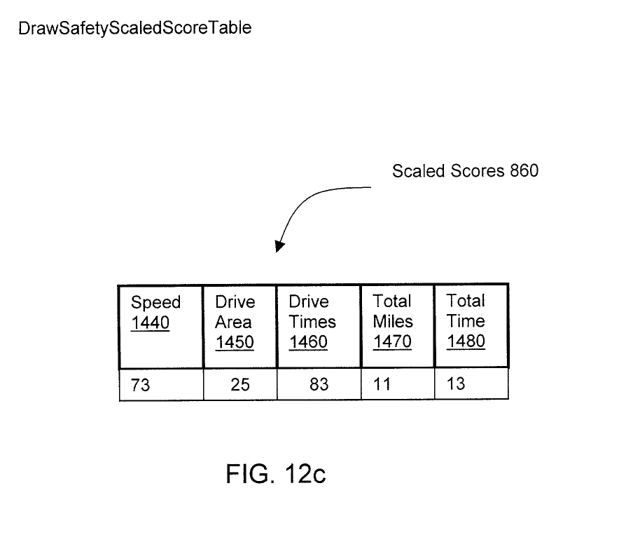

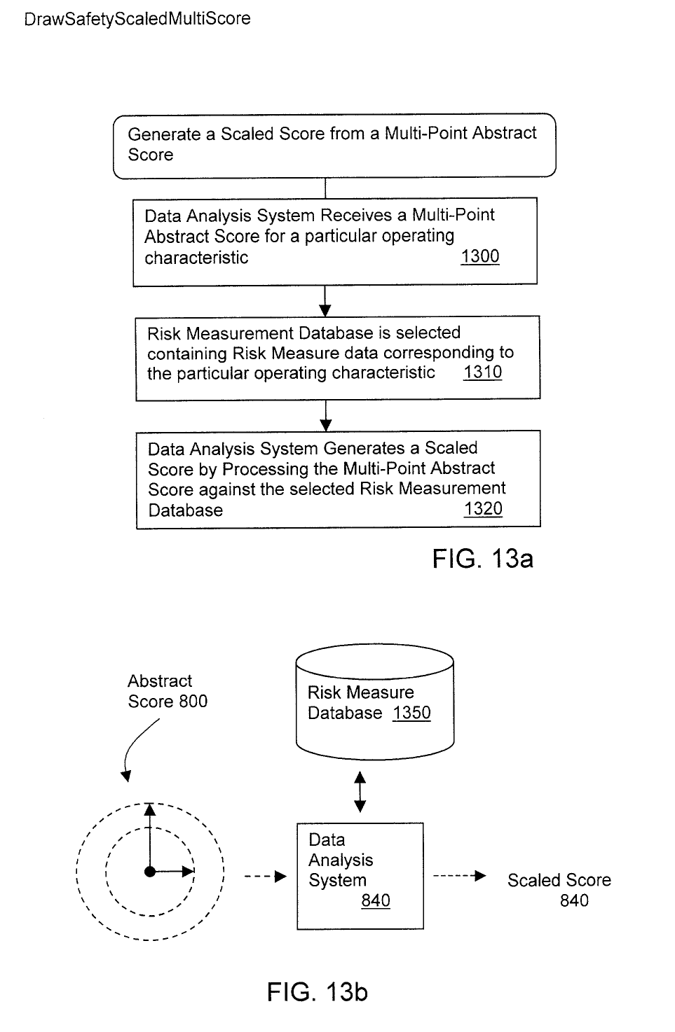

FIG. 12a is a graphical illustration of the relationship between Abstract Scores 800 for a particular operating characteristic and Risk Measures 1240 for that operating characteristic. Risk Measures 1240 could represent any unit of risk measurement, including accident rates, injury rates, death rates or insurance claims that are correlated to a particular operating characteristic. Data Plot 1230 represents the relationship between an Abstract Score Range 1250 and a Risk Measure Range 1245. Abstract Score Range 1250 is preferably the maximum data range of Abstract Scores 800 for a particular operating characteristic measured over the population of all monitored vehicles. Risk Measure Range 1245 represents the range of Risk Measures 1240 that are correlated to the Abstract Scores 800 throughout the Abstract Score Range 1250, either based on projections about the correlation between Abstract Scores 800 and Risk Measures 1240, legacy data from vehicle safety agencies, insurance company records or other sources of legacy data, or from historical information generated from the Crash D&PS 130. Scaling Algorithm 1235 represents a mathematical operation that simulates the relationship shown by Data Plot 1230. In this example, Data Plot 1230 is shown as a continuously increasing relationship between rising Abstract Scores 800 and rising Risk Measures 1240. In certain circumstances Data Plot 1230 may not represent a continuously increasing or decreasing relationship across the Abstract Score Range 1250, and depending on the complexity of the Scaling Algorithm 1235 required to simulate Data Plot 1230, the process for generating Scaled Scores 800 from multi-point Abstract Scores may be utilized as shown in FIG. 13a and FIG. 13b.

FIG. 12b is a flowchart illustrating the process of generating a Scaled Score 860 from a Single-Point Abstract Score. In step 1200 the Data Analysis System 840 receives a Single-Point Abstract Score for a particular operating characteristic. In step 1210 the Data Analysis System 840 identifies a Scaling Algorithm 1235 from the Algorithm Database 1050 that corresponds to the particular operating characteristic, and in step 1220 the Data Analysis System 840 processes the Single-Point Abstract Score through the identified Scaling Algorithm 1235 to generate a Scaled Score 860.

Exemplary Scaled Scores 860 are shown in FIG. 12c for Speed 1440, Drive Area 1450, Drive Times 1460, Total Miles 1470 and Total Time 1480. Speed 1440 may be calculated by the On-Board Data System 80 as a single-point Abstract Score or a multi-point Abstract Score. The vehicle operating data needed to calculate Speed 1440 may be obtained from a GPS receiver or from a speedometer. Drive Area 1450 may be calculated by the On-Board Data System 80 as a single-point Abstract Score or a multi-point Abstract Score. The vehicle operating data needed to calculate Drive Area 1450 may be obtained from a GPS receiver or other location device known to those skilled in the art. Drive Times 1460 may be calculated by the On-Board Data System 80 as a single-point Abstract Score or a multi-point Abstract Score. The vehicle operating data needed to calculate Drive Times 1460 may be obtained from a GPS receiver or from a vehicle clock. Total Miles 1470 may be calculated by the On-Board Data System 80 as a single-point Abstract Score. The vehicle operating data needed to calculate Total Miles 1470 may be obtained from a GPS receiver or from an odometer. Total Time 1480 may be calculated by the On-Board Data System 80 as a single-point Abstract Score. The vehicle operating data needed to calculate Total Time 1480 may be obtained from a GPS receiver or from a vehicle clock.

FIG. 13a is a flowchart illustrating the process of generating a Scaled Score 860 from a multi-point Abstract Score 800. In step 1300 the Data Analysis System 840 receives a multi-point Abstract Score for a particular operating characteristic. Multi-point Abstract Scores may not have a direct relationship to risk through a simple Scaling Algorithm, and may need to be analyzed against a Risk Measure Database 1350, as shown in FIG. 13b. For example, the geographic areas that a particular subscriber drives may not be able to be correlated to risk without knowing the vehicle accident rate in those geographic areas. Similar to Data Plot 1230, Risk Measure Database 1350 represents the relationship between an Abstract Score Range 1250 and a Risk Measure Range 1245 that is too complex to reasonably represent with a Scaling Algorithm 1235. Risk Measure Database 1350 is preferably a relational database. For these multi-point Abstract Scores, the Data Analysis System 840 calculates Scaled Scores 860 by analyzing them against the data in the Risk Measure Database 1350. In step 1310, a Risk Measure Database 1350 is selected that contains Risk Measure 1240 data corresponding to the particular operating characteristic measured by the Multi-Point Abstract Score. In step 1320, the multi-point Abstract Score is then processed against this data to generate a Scaled Score 860.

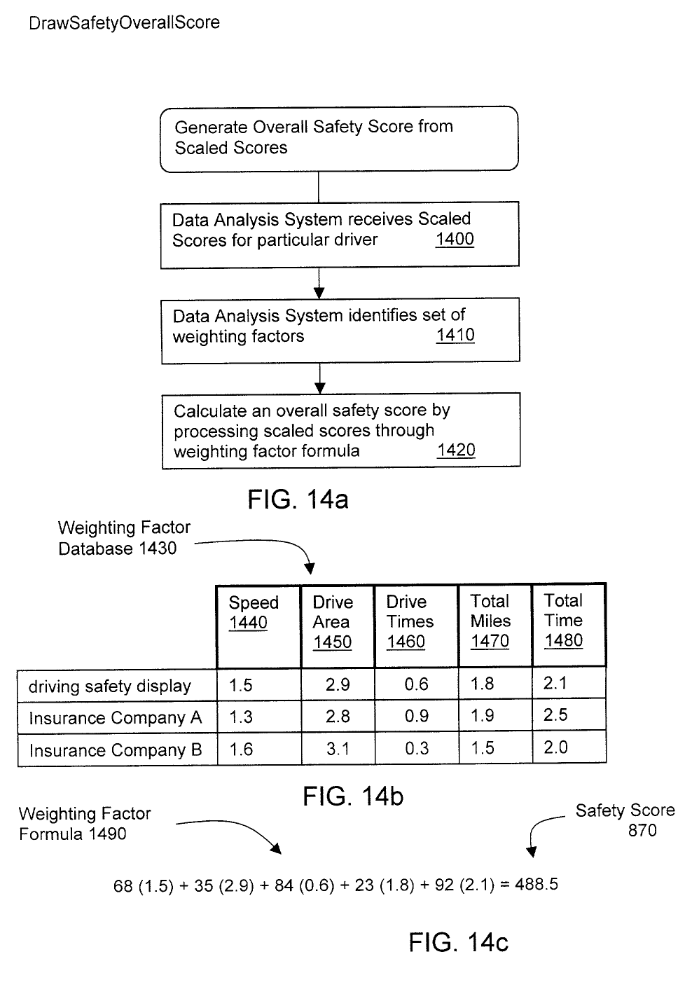

FIG. 14a is a flowchart illustrating the process of generating a Safety Score 870 from Scaled Scores 860. Safety Score 870 is an example of a type of overall risk factor. It enables the consolidation of multiple Scaled Scores 860 into one risk factor that can be used to rank the overall driving safety of a particular Subscriber 170, as well as used by an Insurance Company 190 to establish a specific insurance discount amount or percentage correlated to a single unit that measures risk. To calculate a Safety Score 870, a set of Weighting Factors 1435 is utilized. The purpose of utilizing Weighting Factors 1435 to generate a Safety Score 870 is to take insure that Safety Scores 870 are standardized measurements of overall safety or risk across the entire population of monitored vehicles. Some monitored vehicles may monitor different operating characteristics, thereby resulting in more Scaled Scores 860 for some Subscribers 170 than for others.

Weighting Factors 1435 may be used to insure that a higher Safety Score 870 does not result simply because a Subscriber 170 has a greater number of Scaled Scores 800. In addition, Weighting Factors 1435 may also be needed when Risk Measure 1240 data is unable to completely isolate the risk of a single operating characteristic from other operating characteristics. Additionally, different Insurance Companies 190 may place different weights on particular operating characteristics. Another purpose of Weighting Factors 1435 is to allow different Insurance Companies 190 to select their own set of Weighting Factors 1435 to calculate different Safety Scores 870 for the purposes of determining insurance discounts, giving them flexibility to make adjustments based on their own data without having to input their own Scaling Algorithms 1235 and Risk Measure Database 1350 information. The use of this risk factor enables minimal information to be transmitted to an insurance company, maximizing the privacy protection of the subscriber while still providing the insurance company accurate rating information. Risk factors used as part of this system could be expressed in many ways, including a points-based system where only those subscribers whose risk factor is above a certain threshold receive points.

In FIG. 14a according to step 1400 Scaled Scores 860 are received by the Data Analysis System 840. In step 1410 a set of Weighting Factors 1435 is identified within a Weighting Factor Database 1430. As shown in FIG. 14b, the Weighting Factor Database 1430 may include Weighting Factors 1435 used to provide subscribers with standardized feedback regarding their driving safety as well as weighting factors specified by individual Insurance Company 190. In step 1420 a Safety Score 870 is calculated by processing the Scaled Scores 860 through a Weighting Factor Formula 1490 containing the Weighting Factors 1435. FIG. 14c is an exemplary illustration of a Weighting Factor Formula 1490 that may be used to calculate a Safety Score 870. Exemplary Weighting Factors 1435 are shown in FIG. 14b for Speed 1440, Drive Area 1450, Drive Times 1460, Total Miles 1470 and Total Time 1480. Sets of Exemplary Weighting Factors 1435 are shown in FIG. 14b for calculation of Safety Scores 870 for display to Subscribers 170 as well as for calculation of Safety Scores 870 specific to particular Insurance Companies 190 based on their own sets of Weighting Factors 1435.

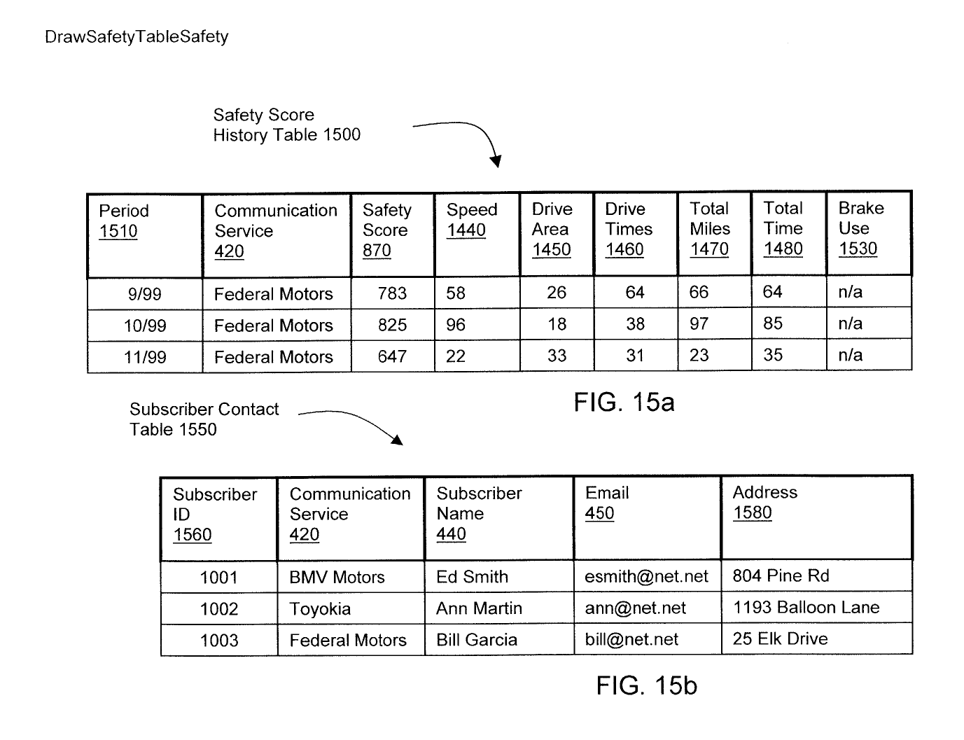

FIG. 15a illustrates an exemplary Safety Score History Table 1500 that stores the historical Scaled Scores 860 and Safety Scores 870 for a particular Subscriber 170. The purpose of the Safety Score History Table 1500 is to allow Data Users 150 to evaluate the safety record of a particular Subscriber 170. For example, the Subscriber 170 may want to view their own record to see if their safety is improving. The Safety Score History Table 1500 also provides information for Insurance Companies 190 that may want to offer a Subscriber 170 an insurance discount based on their historical score data. Period 1510, here shown as specific months, identifies the time period to which a set of score data corresponds. The Communication Service 420 to which the Subscriber 170 was using during the Period 1510 is also shown. The Safety Score 870 is shown for a Period 1510, as well as Scaled Scores 860 for the operating characteristics of Speed 1440, Drive Area 1450, Drive Times 1460, Total Miles 1470, Total Time 1480 and Brake Use 1530. Brake Use 1530 is an exemplary vehicle operating characteristic that may be calculated by the On-Board Data System 80 from Vehicle System Sensors 210. Brake Use 1530 may be represented as a single-point Abstract Score representing total brake light activations during a period or a multi-point Abstract Score representing brake light activations as a function of another variable, such as at different speed levels. The vehicle operating data needed to calculate Brake Use 1530 may be obtained from the brake light system, accessible to the On-Board Data System 80 across the vehicle data bus. A similar Abstract Score 800 may be generated in a similar manner for turn signal use.

FIG. 15b illustrates an exemplary Subscriber Contact Table 1550 that is used by the Data Delivery and Processing System 130 to facilitate communication with a Subscriber 170. An example of a communication may be sending a Subscriber 170 their latest score data in an email that contains a web link to a web page that contains their latest score data. Subscriber Contact Table 1550 includes a Subscriber ID 1560 and Subscriber Name 440 to identify the correct Subscriber 170, and an identification of the Communication Service 420 so that documents or communications to the Subscriber 170 generated by the Data D&PS 130 may reference the appropriate communication service provider. Email 450 and Address 1580 are exemplary address information that is preferably obtained from the Subscriber Data 117 of a Subscriber Database 115 maintained by the Communication Service 420.

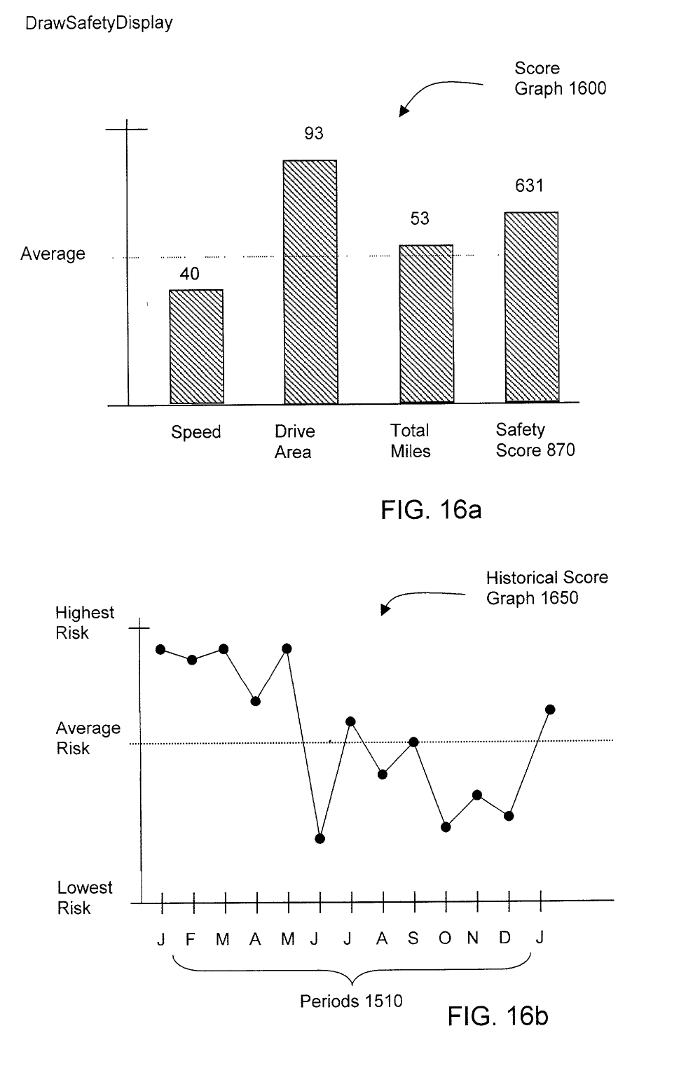

FIG. 16a illustrates an exemplary Score Graph 1600 of score data for a particular Period 1510. The purpose of the Score Graph 1600 is to communicate information to a Subscriber 170 about their safety based on their vehicle operating characteristics in an easily understandable manner. Score Graph 1600 is shown as displaying Scaled Scores 860 and a Safety Score 870 on the same graph and indicating their deviation from average scores. FIG. 16b illustrates an exemplary Historical Score Graph 1650 of score data for a series of Periods 1510. Score Graphs 1600 may present information either based on Risk Measures 1240, or based on how the operating characteristics of a Subscriber 170 compare to those in a population of Subscribers 170.

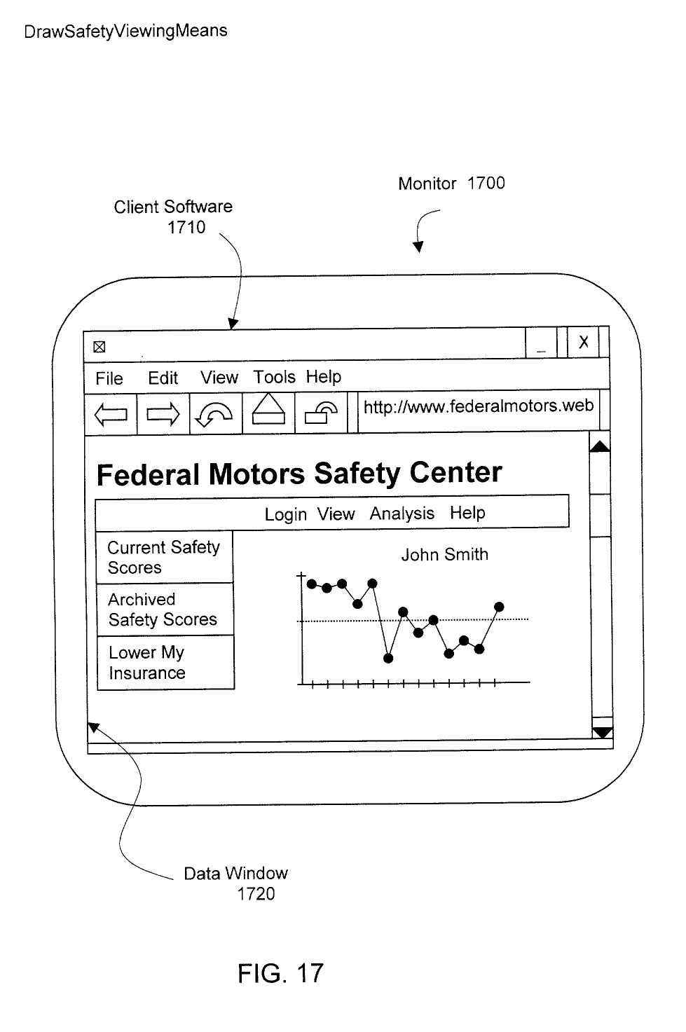

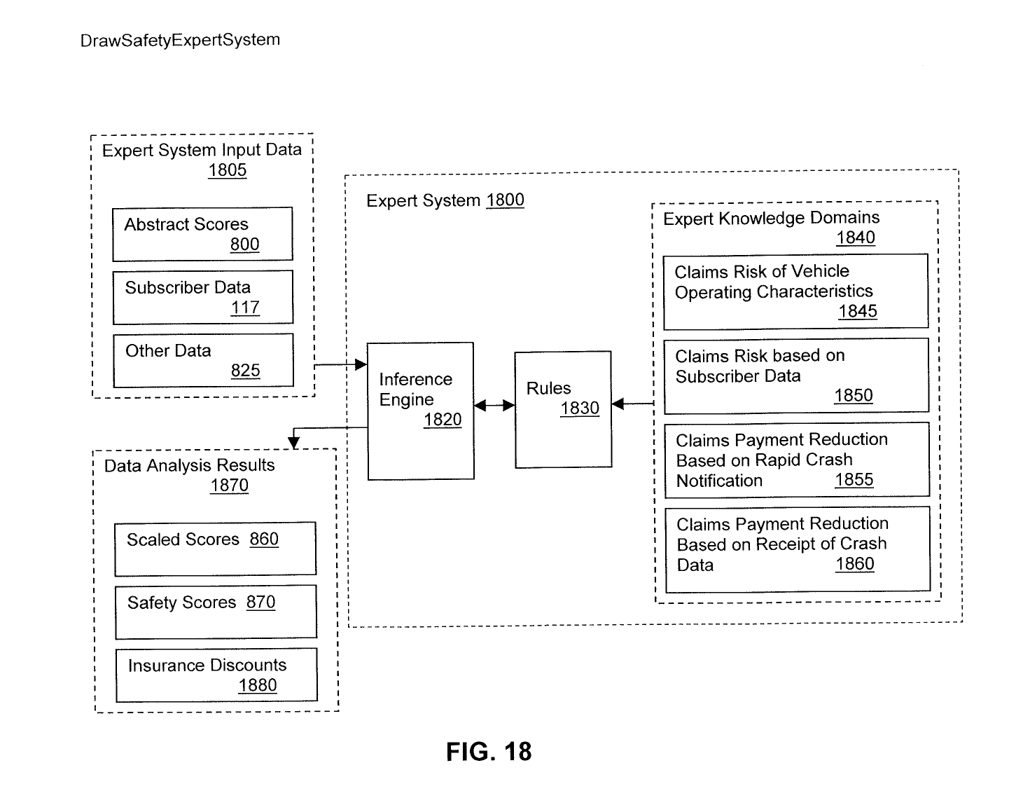

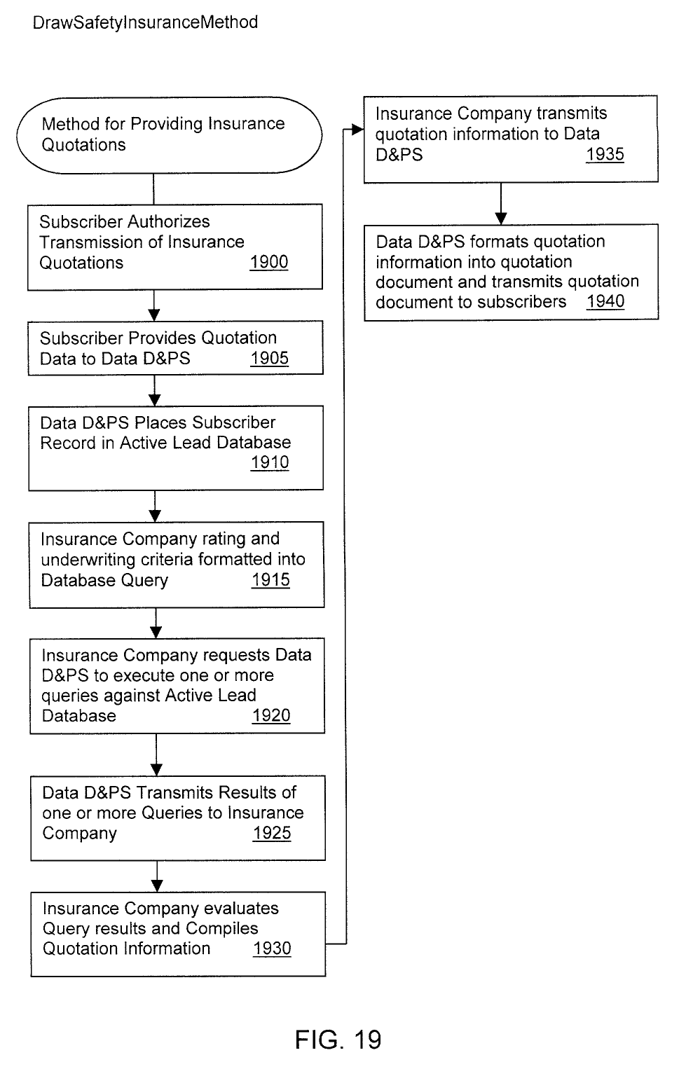

FIG. 17 shows an exemplary user interface for the Data Delivery and Processing System 130 that may be displayed to a Data User 150 through the Network 140. A Monitor 1700 is shown, which could be any computer monitor suitable for displaying data through personal computer software, including a standard PC monitor or monitor from a notebook, laptop, or other form of mobile computing device. Client Software 1710 is preferably a standard internet browser that can be downloaded through Network 140. The Data Window 1720 displays the data from the Data Delivery and Processing System 130, including Score Graphs 1600, Historical Score Graphs 1650, and other information that is input into or processed within the Data D&PS 130.

FIG. 18 shows an application within the Data Analysis System 840 in the form of an Expert System 1800. As more knowledge is gained about the relationship between operating characteristics and Risk Measures 1240, more accurate risk analysis may be possible through more complex processing of operating characteristic data. The purpose of the Expert System 1800 is to provide more accurate analysis of risk by analyzing the interrelationships between Abstract Scores 800, Subscriber Data 117 and Other Data 825. The purpose of analyzing these interrelationships is to determine how they impact overall risk, and therefore should be reflected in Scaled Scores 860, Safety Scores 870 and Insurance Discounts 1880. An Expert System 1800 is shown which automatically generates Scaled Scores 860, Safety Scores 870 and other Insurance Discount Information 1880 based on Expert System Input Data 1805. Expert System Input Data 1800 may include Abstract Scores 800, Subscriber Data 117, and Other Data 825. An Inference Engine 1820 is used to generate Data Analysis Results 1870 based on Rules 1830 Established by experts in various Expert Knowledge Domains 1840 including Claims Risk of Vehicle Operating Characteristics 1845, Claims Risk Based on Subscriber Data 1850, Claims Payment Reduction Based on Rapid Crash Notification 1855 and Claims Payment Reduction Based on Receipt of Crash Data 1860. Inference Engine 1820 may utilize any rules-based logic scheme, including use of boolean algorithms to generate Data Analysis Results 1870 from Rules 1830.

FIG. 19 illustrates an exemplary process for providing insurance quotations based on stored Subscriber Data 117 and On-board sensor data processed within the Data D&PS in the form of a batch-quote query system. As shown in step 1900 a Subscriber 170 provides authorization for insurance quotations to be sent to the Subscriber 170. In step 1905 the Subscriber 170 provides Quotation Data 2100 to the Data D&PS 130. Quotations data is required in order for the Data D&PS 130 to know the type and amount of insurance coverage sought by the Subscriber 170. In step 1910 the Data D&PS 130 places the Subscriber Record into the Active Lead Database 950 making it available for query by a Insurance Companies 190. In step 1915 an Insurance Company 190 rating and underwriting criteria is formatted into a database query. In step 1920 the Insurance Company 190 requests that the Data D&PS 130 provide results to one or more queries against the Active Lead Database 950. In step 1925 the Data D&PS 130 provides query results to the Insurance Company 190. In step 1930 the Insurance Company 190 evaluates the query results and compiles quotation information. In step 1935 the Insurance Company 190 transmits quotation information to the Data D&PS 130. In step 1940 the Data D&PS 130 formats quotation information into a quotation communication document to the Subscribers 170 and transmits the document to the Subscribers 170.

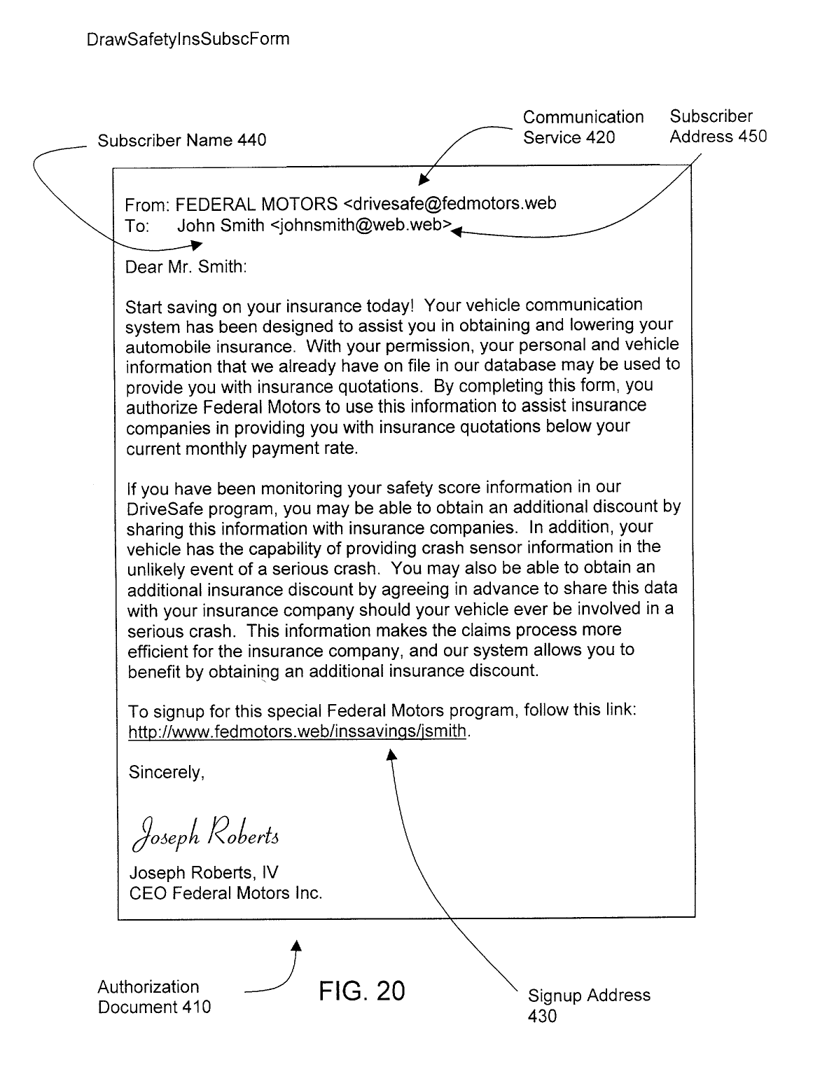

FIG. 20 illustrates an exemplary Authorization Document 410 requesting subscriber authorization to provide the Subscriber 170 with insurance quotations, here shown in the form of an email. The Communication Service 420 indicates the provider of the vehicle communication service from which the subscriber receives service. The Subscriber Name 440 and Subscriber Address 450, shown here as an email address, may be obtained from the Subscriber Database 115. A Signup Address 430 is shown, here in the form of a website link, allowing the Subscriber 440 to authorize the transmission of insurance quotations to the Subscriber 170.

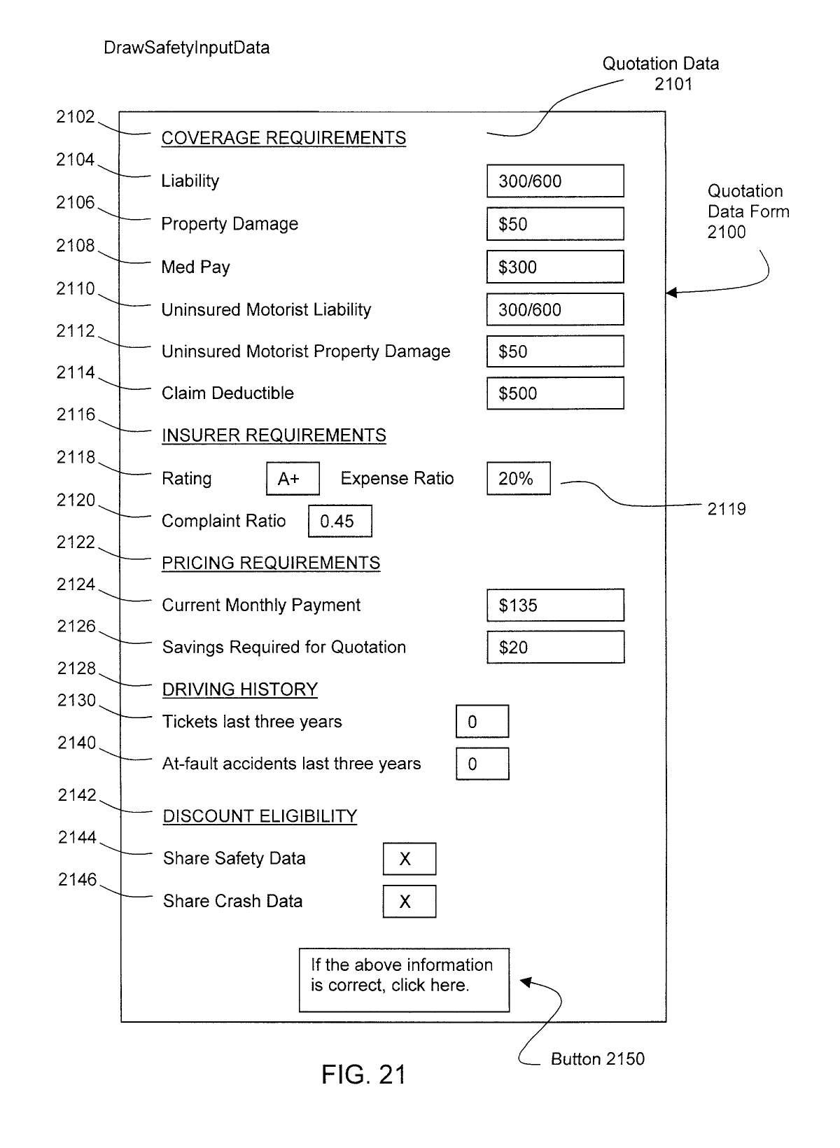

FIG. 21 illustrates an exemplary Quotation Data Form 2100, here shown as a computer form, that allows a Subscriber 170 to provide additional data that may be utilized to provide an insurance quotation. Coverage Requirements 2102 represent the types and amounts of insurance coverage that is desired by the Subscriber 170. These may include Liability 2104, Property Damage 2106, Med Pay 2108, Uninsured Motorist Liability 2110, Uninsured Motorist Property Damage 2112 and Claim Deductible 2114 amounts. These fields may all be filled in with default amounts, requiring the Subscriber 170 to change them only if they are incorrect amounts. Insurer Requirements 2116 represent performance attributes of the Insurance Company 190 that the Subscriber 170 may require in order to receive quotations from the Insurance Company 190. Rating 2118 represents a measurement of a variety of performance and quality factors of an Insurance Company, including for example its financial strength, quality of management and market share. Several companies are known to provide independent ratings of insurance companies. Expense Ratio 2119 represents a measurement that can be used to predict the performance, health or competitiveness of a particular insurance company. In general, the lower the expense ratio of a given insurance company, the more money that insurance company has to devote to lowering its rates or improving its claims handling process. Complaint Ratio 2120 is a measurement of the number of complaints received by a state department of insurance per 1,000 policies in force, and may be used as a gross predictor of claims handling performance of an insurer. Insurer Requirements 2116 fields may also be filled with default parameters, reducing the amount of data entry required of the Subscriber 170 if the default parameters are acceptable. Pricing Requirements 2122 are a measurement of the financial criteria required by the Subscriber 170 to receive an insurance quotation. Pricing Requirements 2122 may include a Current Monthly Payment 2124 parameter and a Savings Required for Quotation 2126 parameter to establish a ceiling price which must be cleared by an insurance quotation in order for the insurance quotation to be sent to the Subscriber 170. The Savings Required for Quotation 2126 field may also be filled with a default amount. Driving History 2128 provides an Insurance Company 190 with a measurement of the claims risk posed by a Subscriber based on their past driving history. Driving History 2128 may include fields for Tickets Last Three Years 2130 and Accidents Last Three Years 2140, both of which may be filled with default amounts. Discount Eligibility 2142 contains fields where a Subscriber 170 may specify the types of vehicle sensor data they are willing to share with an Insurance Company 190 to obtain an additional discount. Selection of Share Safety Data 2144 by a Subscriber 170 would authorize historical Scaled Scores 860 and Safety Scores 870 stored in the Data D&PS 130 for that Subscriber 170 to be shared with the Insurance Company 190. These Scaled Scores 860 and Safety Scores 870 may be those calculated by the Scaling Algorithms 1235, Risk Measure Databases 1350 and Weighting Factors 1435 that represent the defaults used by the Data D&PS 130 to provide safety analysis information to Subscribers 170, or may represent Scaled Scores 860 and Safety Scores 870 calculated based on Weighting Factors 1435, Scaling Algorithms 1235 or Risk Measures 1240 specified by a particular Insurance Company 190 desiring to quote insurance. The Insurance Company 190 may use this information to provide the Subscriber 170 with an insurance discount based on their past safety record as reflected in the historical score data. Selection of Share Crash Data 2146 by a Subscriber 170 would authorize data obtained from vehicle sensors during a crash event to be transmitted to the Subscriber's 170 then current Insurance Company 190. The Insurance Company 190 may use this information in their claims handling process, and may give the Subscriber 170 an insurance discount for agreeing to share this information. These fields may also be filled with default parameters. Once the form is complete, Button 2150 may be clicked with a computer pointer device in order to proceed to the next input screen. Button 2150 is shown configured for a batch-quote query system, but could also send the information directly to one or more insurance companies to request a prompt insurance quotation. Some of the parameters in FIG. 21 will be dictate by State insurance regulations, including coverage types and discounts. Quotation Data Form 2100 may vary from State to State based on these regulations.

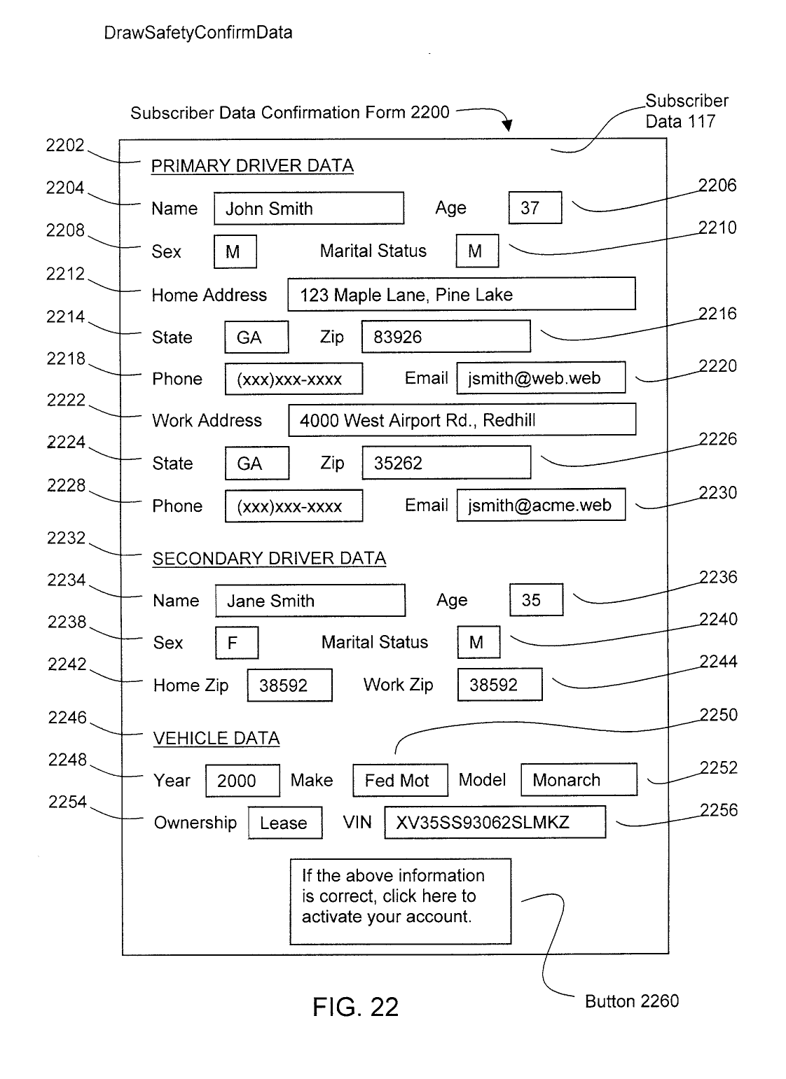

FIG. 22 is an exemplary illustration of a Subscriber Data Confirmation Form 2200 that may be utilized to confirm the accuracy of Subscriber Data 117 transferred to the Data Delivery and Processing System 130 from the Subscriber Database 115. Primary Driver Data 2202 contains information about the primary vehicle driver that was likely to have been previously captured by the subscriber's Communication Service 420 and input into a Subscriber Database 115. This information may include Name 2204, Age 2206, Sex 2208, Marital Status 2210, Home Address 2212, State 2214, Zip 2216, Phone 2218, Email 2220, Work Address 2222, State 2224, Zip 2226, Phone 2228 and Email 2230. This information may be used by an Insurance Company 190 to determine whether they will provide a quotation for the particular Subscriber 170, and if so, what the quoted rate will be. Secondary Driver Data 2232 contains information about other drivers that may also have been previously captured by the Subscriber's Communication Service 420 and input into a Subscriber Database 115. This information is shown here including Name 2234, Age 2236, Sex 2238, Marital Status 2240, Home Zip 2242 and Work Zip 2244. The specific data elements contained within Primary Driver Data 2202 and Secondary Driver Data 2232 will depend upon the data captured by the vehicle communication service provider from the Subscriber 170, as well as the need of Insurance Companies 190 in order to accurately quote insurance. This information may be used by an Insurance Company 190 to determine whether they will provide a quotation for the particular Subscriber 170, and if so, what the quoted rate will be. Vehicle Data 2246 contains information about the vehicle that the Subscriber 170 desires to insure that may also have been previously captured by the Subscriber's Communication Service and input into a Subscriber Database 115. This information may include Year 2248, Make 2250, Model 2252, Ownership 2254 and VIN 2256. VIN 2256 represents the Vehicle Identification Number for the vehicle. This information may be used by an Insurance Company 190 to determine whether they will provide a quotation for the particular Subscriber 170, and if so, what the quoted rate will be. Once a Subscriber 170 has completed this form, they may click the Button 2260 with a computer pointer device to activate their account and have this information placed into the Active Lead Database 950. Authorization Document 410, Quotation Data Form 2100 and Subscriber Data Confirmation Form 2200 could take on other forms, such as a mailer that includes an Authorization Document 410 in the form of a letter with an attached form and a Quotation Data Form 2100 and Subscriber Data Confirmation Form 2200 in the form of paper forms that are pre-completed with subscriber data and default data.

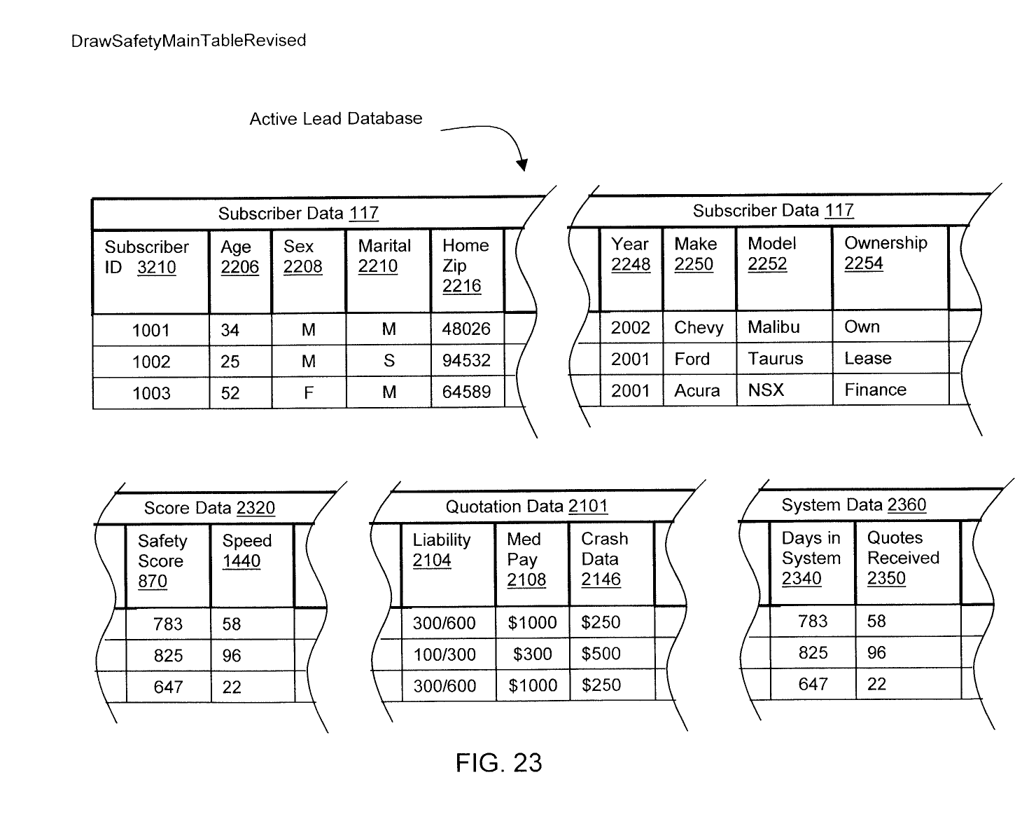

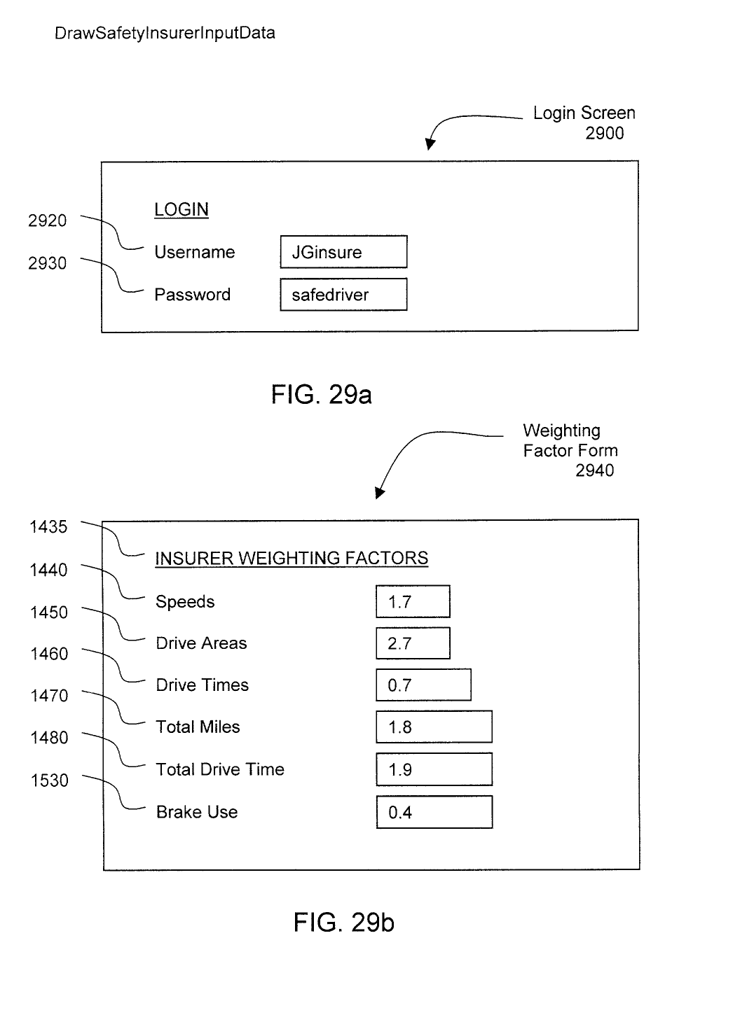

FIG. 23 is an exemplary excerpt of an Active Lead Database 950 that contains information about Subscriber's 170 that wish to receive insurance quotations from Insurance Companies 190. The Active Lead Database 950 is shown containing Subscriber Data 117, Score Data 2320, Quotation Data 2101 and System Data 2360. A Subscriber ID 2310 is assigned for identification of particular records. Subscriber Data 117 represents data confirmed with subscribers by a Subscriber Data Confirmation Form 2200 (See FIG. 22). Score Data 2320 represents data transferred from the Safety Subscriber Database 940, including Scaled Scores 860 and Safety Scores 870. Additional Calculations may be performed by the Data Analysis System 840 to recalculate Scaled Scores 860 and Safety Scores 870 based on different Algorithms 1230, Risk Factor Databases 1350 and Weighting Factors 1435 for different Insurance Companies 190 (See FIG. 29b). Quotation Data 2101 represents data obtained from Quotation Data Forms 2100 (See FIG. 21). Some of the Subscriber Data 117 within Active Lead Database 950 can also be replaced or supplemented with verified data obtained based on analysis of Abstract Score Data 95, including Home Zip 2216, Work Zip 2226 and other information that might be typically requested by an insurance company for rating purposes such as average miles driven each year, commute distance and garage storage and location—all of which can be derived based on analysis of Abstract Score Data 95 within the Data D&PS 130. These rating factors are highly subject to fraud, and Subscribers 170 providing verified data about these ratings factors may be entitled to lower insurance rates based on the elimination of potential fraud. These verified data elements can be communicated to the Subscriber 170 in Subscriber Data Confirmation Form 2200 (FIG. 22) or Quotation Data Form 2100 (FIG. 21), allowing the Subscriber 170 to review the verified data prior to enabling insurance companies to access this data.

System Data 2360 represents data from calculations performed on the Active Lead Database 950 by the Data Analysis System 840 to provide an Insurance Company 190 with statistical information about the records contained within the Active Lead Database 950. Here, System Data 2360 is shown as Days in System 2340, which indicates how many days a Subscriber record has been in the Active Lead Database 950, and Quotes Received 2350 which indicates how many quotes the Subscriber 170 has been offered during that time.

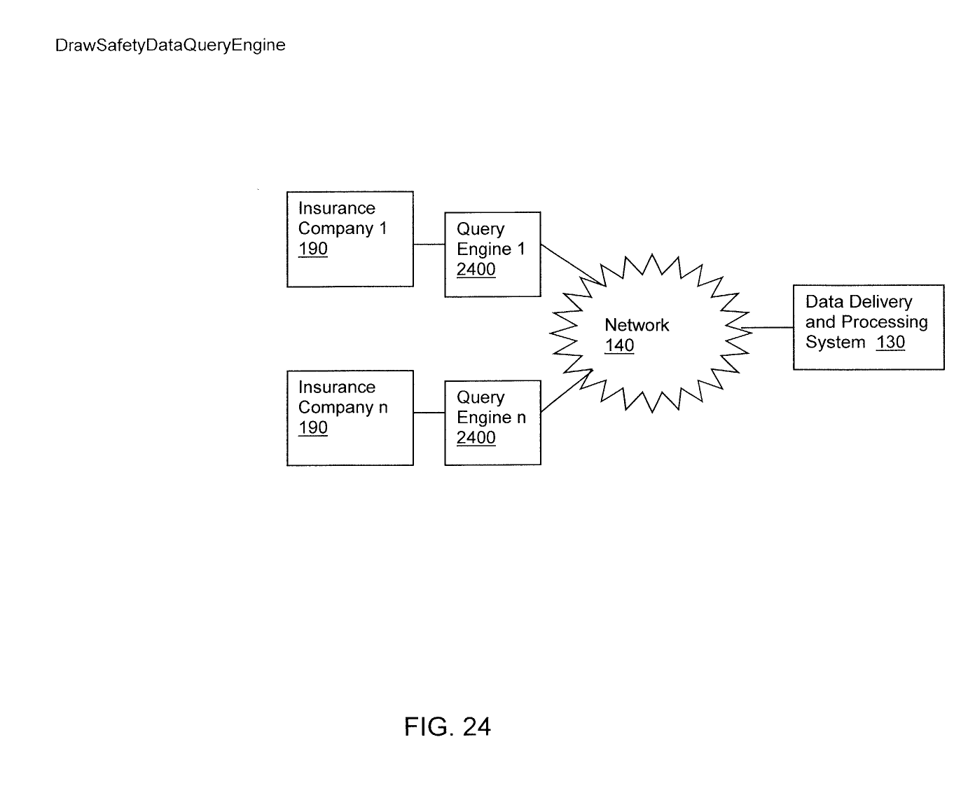

FIG. 24 is a block diagram of an exemplary configuration of insurance companies 190 accessing the Data Delivery and Processing System 130 under a batch-quote query configuration. Here, Query Engine 2400 is shown as being located on the Insurance Company side of the Network 140. This may be desirable for Insurance Companies 190 concerned about protecting their proprietary rating and underwriting criteria. Alternatively, Query Engine 2400 could be located within the Data D&PS 130.

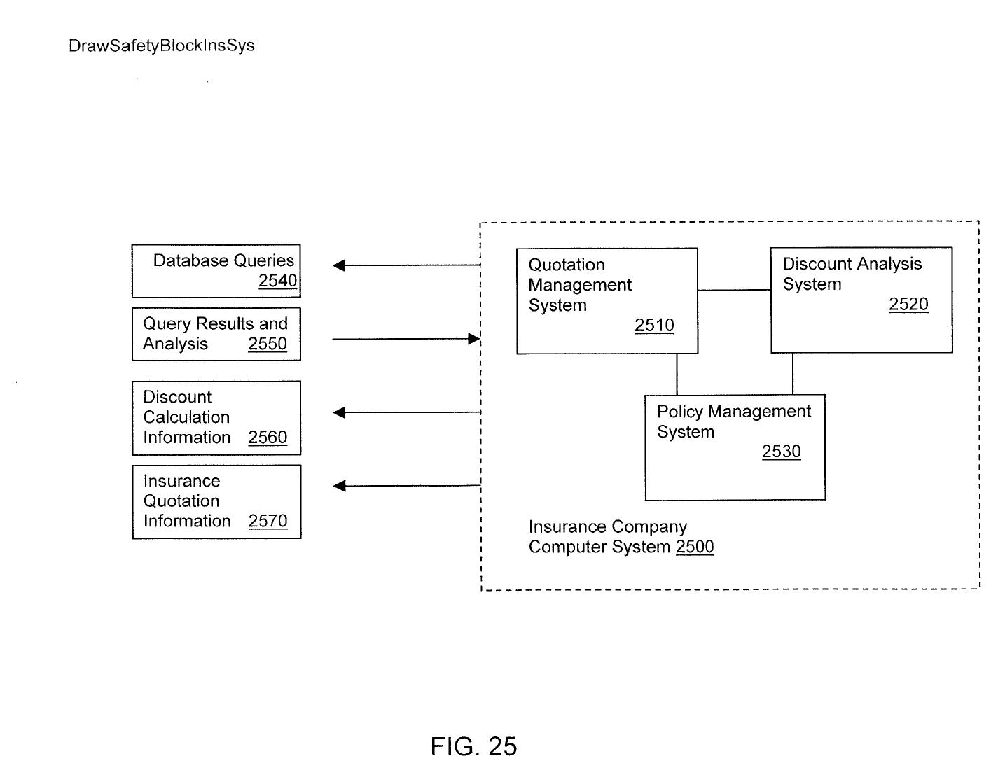

FIG. 25 is a block diagram of an exemplary Insurance Company Computer System 2500. Insurance Company Computer System 2500 is shown as including a Quotation Management System 2510, Discount Analysis System 2520 and a Policy Management System 2530. The Quotation Management System 2510 may be configured to provide individual quotes, or to process batch-quote queries against the Active Lead Database and for managing the submission of offers to Subscribers. The Discount Analysis System 2520 is configured to compute insurance discounts based on risk information. The Policy Management System 2530 is configured to manage policy transactions for Subscriber's accepting quotation terms. Some or all of these components may be located with the Data Delivery and Processing System 130 depending upon the needs and sophistication of the particular Insurance Company 190.

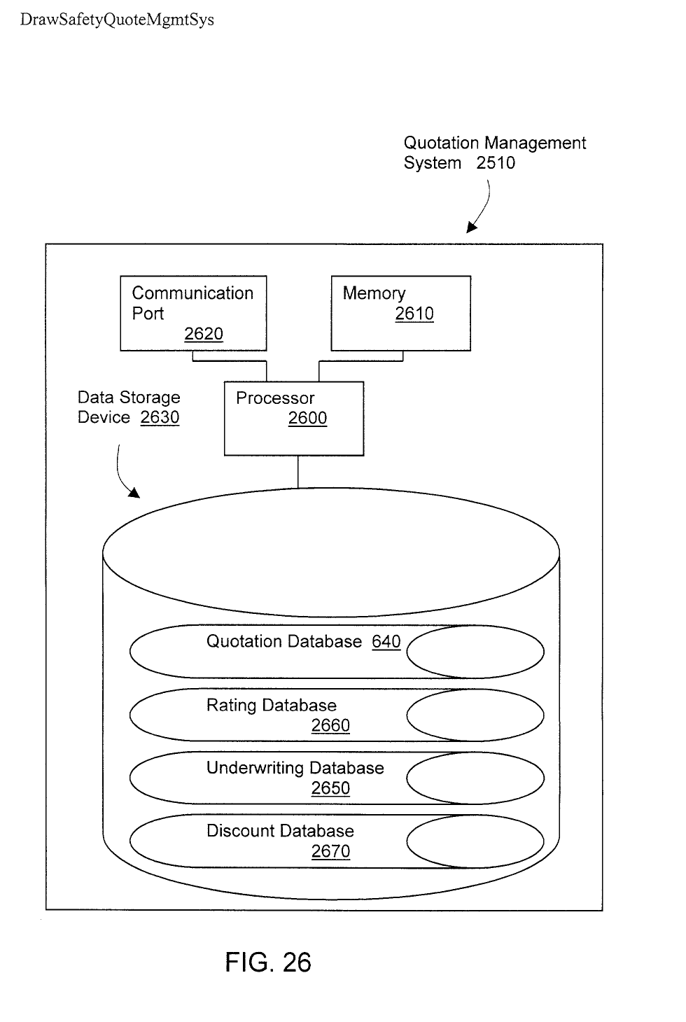

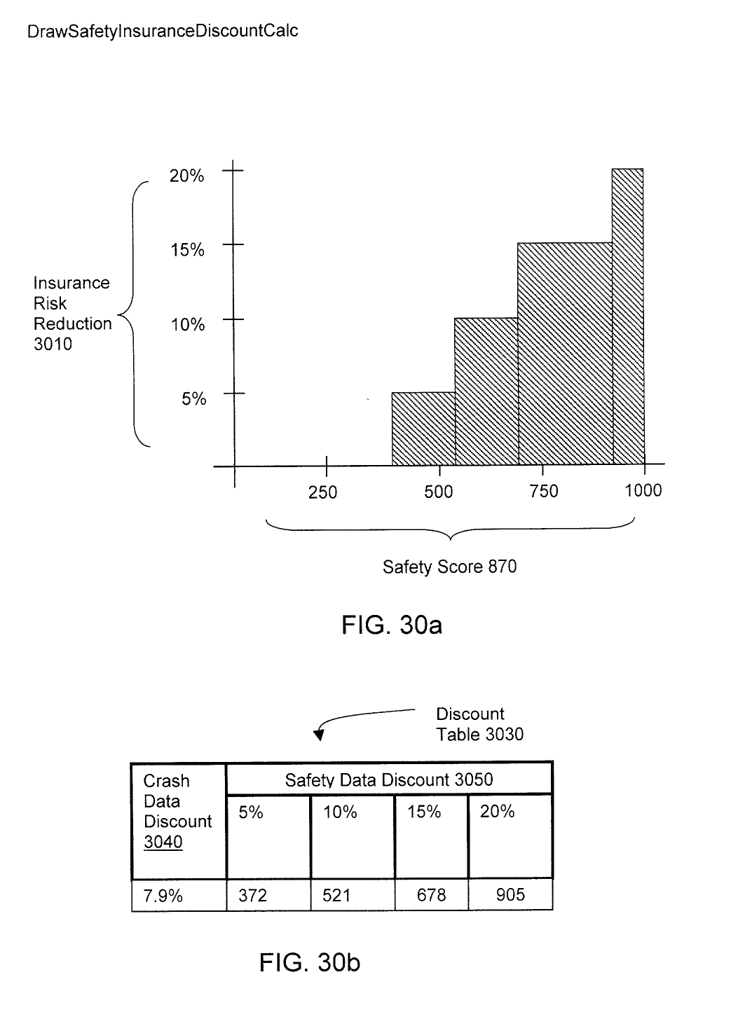

FIG. 26 depicts a block diagram of a Quotation Management System 2510, shown as a central database server. The Data Storage Device 2630 is shown which may contain a variety of databases, including Quotation Database 2640, Underwriting Database 2650, Rating Database 2660 and Discount Database 2670. The Quotation Management System 2510 includes a Processor 2600, Communication Port 2620 and Memory 2610 for managing the operations of the Quotation Management System 2510, which may include: (1) providing individual insurance quotations; (2) formatting of queries against the active lead database; (3) management of insurance discount information; (4) management of pending, accepted and rejected insurance quotations. The purpose of the Quotation Database 2630 is to keep track of quotations submitted to Subscribers 170. The purpose of the Underwriting Database 2650 and Rating Database 2660 is to provide the Insurance Company 190 criteria for underwriting and rating insurance policies. This information will provide the basis for quotations sent to subscribers or queries submitted through Query Engine 2400, along with information received from the Discount Analysis System 2520. Underwriting Database 2650 and Rating Database 2660 are databases proprietary to the Insurance Company 190. An exemplary Discount Database 2670 is shown in FIG. 30b.

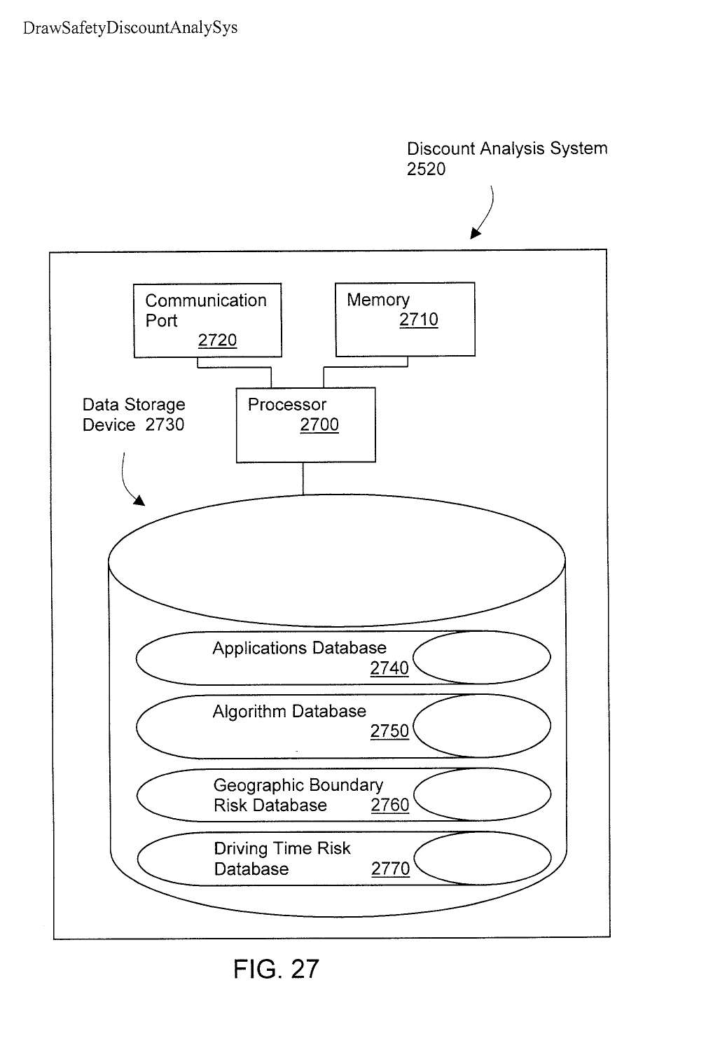

FIG. 27 depicts a block diagram of a Discount Analysis System 2520, shown as a central applications server. The Data Storage Device 2730 is shown which may contain a variety of databases, including Applications Database 2740, Algorithm Database 2750, Geographic Boundary Risk Database 2760 and Driving Time Risk Database 2770. The Discount Analysis System 2520 includes a Processor 2700, Communication Port 2720 and Memory 2710 for managing the operations of the Discount Analysis System 2520, including: (1) calculating insurance discount information for the Quotation Management System 2510; (2) analyzing risk measures against abstract data; and (3) calculating algorithms and weighting factors. Applications Database 2740 may contain a variety of calculation programs for analyzing risk measures and generating algorithms and weighting factors. Algorithm Database 2750 contains any special Weighting Factors 1435 specific to the Insurance Company 190 as well as any Scaling Algorithms 1235 specific to the Insurance Company 190. The Data D&PS 130 may utilize information from the Algorithm Database 2750 to generate Safety Scores 860 and Scaled Scores 870 specific to a particular Insurance Company 190. Geographic Boundary Risk Database 2760 and Driving Time Risk Database 2770 are exemplary Risk Measure Databases 1350 that may be used by the Discount Analysis System 2520 in analyzing Risk Measures 1240 and calculating Scaling Algorithms 1235 and Weighting Factors 1435. The Data D&PS 130 may also utilize these databases to generate Scaled Scores 860 specific to a particular Insurance Company 190.

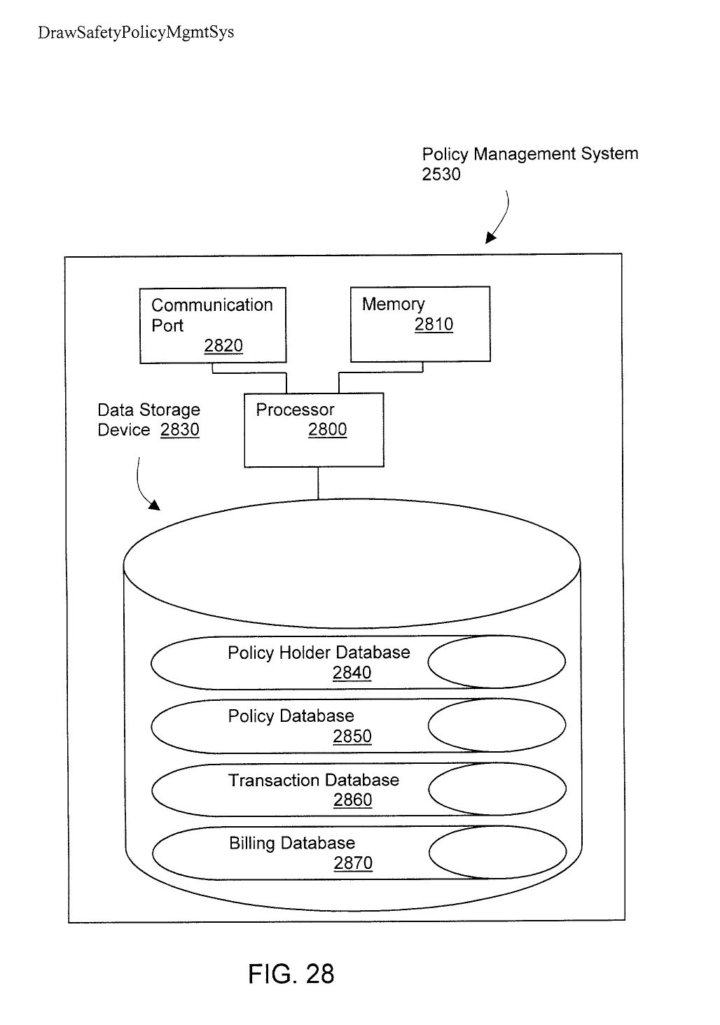

FIG. 28 depicts a block diagram of a Policy Management System 2530, shown as a central database server. The Data Storage Device 2830 is shown which may contain a variety of databases, including Policy Holder Database 2840, Policy Database 2850, Transaction Database 2860 and Billing Database 2870. These databases allow the Insurance Company 190 to execute an insurance policy transaction with a Subscriber 170, and their specific configurations and operations will be determined by the Insurance Company 190. The Policy Management System 2530 includes a Processor 2800, Communication Port 2820 and Memory 2810 for managing the operations of the Policy Management System 2310, including: (1) managing policy purchase transactions; (2) maintaining records of policy holder interactions; (3) managing the billing records of policy holders; and (4) updating policy types and offered coverage parameters.

FIG. 29a illustrates an exemplary Login Screen 2900 for a Data User 150 such as an Insurance Company 190 to access the Data D&PS 130. A Username 2920 and Password 2930 are shown with fields that a Data User 150 must complete prior to receiving access to the Data D&PS 130. FIG. 29b illustrates an exemplary Weighting Factor Form 2940 that may be completed by an Insurance Company 190 to input its own set of Weighting Factors 1435 into the Data D&PS 130. Exemplary Weighting Factors 1435 are shown as Speeds 1440, Drive Areas 1450, Drive Times 1460, Total Miles 1470, Total Drive Time 1480 and Brake Use 1530. These insurer-specific Weighting Factors 1435 may then be used to calculate a Safety Score 870 specific to the Insurance Company 190, and which may be utilized by the Discount Analysis System 2520 of the Insurance Company 190 to calculate an insurance discount.

FIG. 30a illustrates a graphical representation of the relationship between Insurance Risk Reduction 3010 and a Safety Score 870 that may be used as the basis for providing an insurance discount to a Subscriber 170 based on their Safety Score 870. This relationship will also be the basis of filings by the Insurance Company 190 with State insurance regulatory agencies regarding the basis for offering the discount. FIG. 30b illustrates an exemplary Discount Table 3030 from the Discount Database 2670 of a Quotation Management System 2510 containing discount percentages linked to the sharing of crash event data and specific Safety Scores 870. Crash Data Discount 3040 is shown as a percentage discount based on the sharing of crash event data. Safety Data Discount 3050 is shown as a series of percentage discounts that are applied based on Safety Score 870 thresholds determined by the Discount Analysis System 2520. The specific discount configurations, units of measurement and amounts will be determined by the particular Insurance Companies 190.

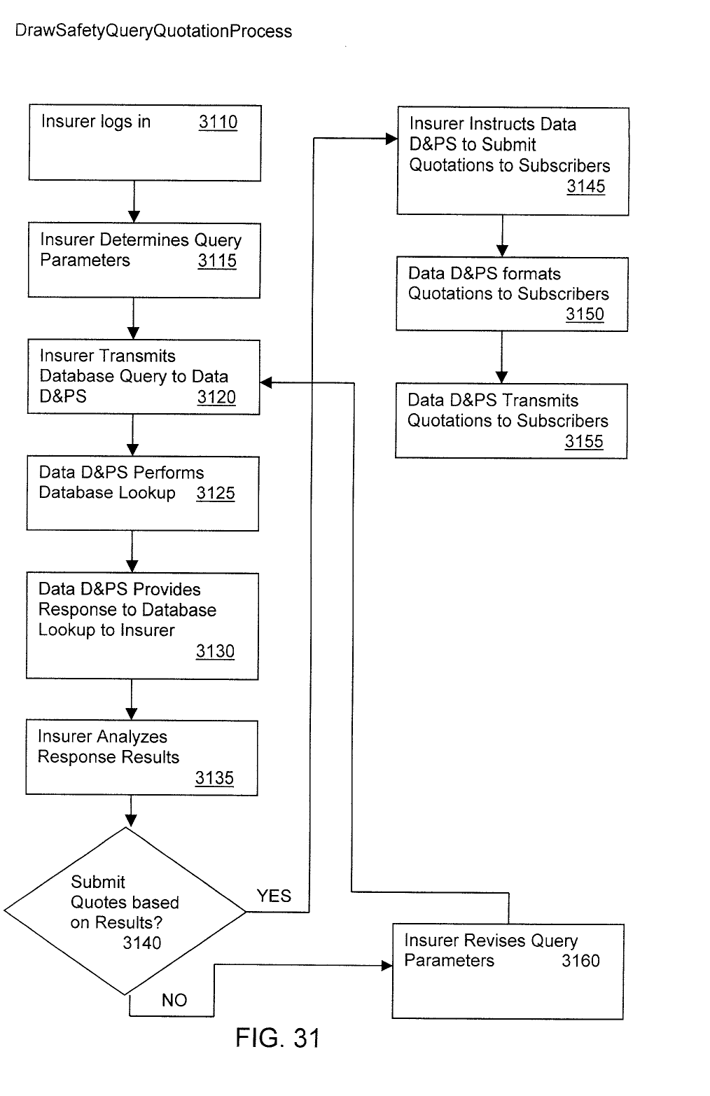

FIG. 31 illustrates a process for generating insurance quotes for Subscribers 170 within the Active Lead Database 950. In step 3110 an Insurance Company 190 logs into the Data Delivery and Processing System 130. In step 3115, the Insurance Company 190 determines query parameters for identifying Subscribers 170 within the Active Lead Database 950 that meet the underwriting and rating requirements of the Insurance Company 190. In step 3120 the query parameters are submitted to the Data Management System 830 for analysis against the Active Lead Database 950. In step 3125, the Data Management System 830 executes a database lookup against the Active Lead Database 950. In step 3130 the Data Management System 830 provides a response to the Insurance Company containing the results of the database lookup. In step 3135 the Insurance Company analyzes the database lookup response to determine if the Insurance Company would like to provide quotations to the Subscribers 170 selected from the Active Lead Database 950 as meeting the query parameters. In step 3140 the Insurance Company 190 decides to either submit quotations to the identified subscribers, or to proceed to step 3160 and revise its query parameters. Successive levels of drill-down queries may be required to isolate a population of Subscribers 170 that match the Insurance Company 190 query criteria. If the Insurance Company 190 decides to submit quotations to the identified subscribers, the Insurance Company 190 instructs the Data Delivery and processing System 130 to submit quotations in step 3145. In step 3150 the Data Delivery and Processing System 130 formats quotation documents for transmission to subscribers based on the quotation information. In step 3155 the Data Delivery and Processing System 130 transmits quotation documents to subscribers.

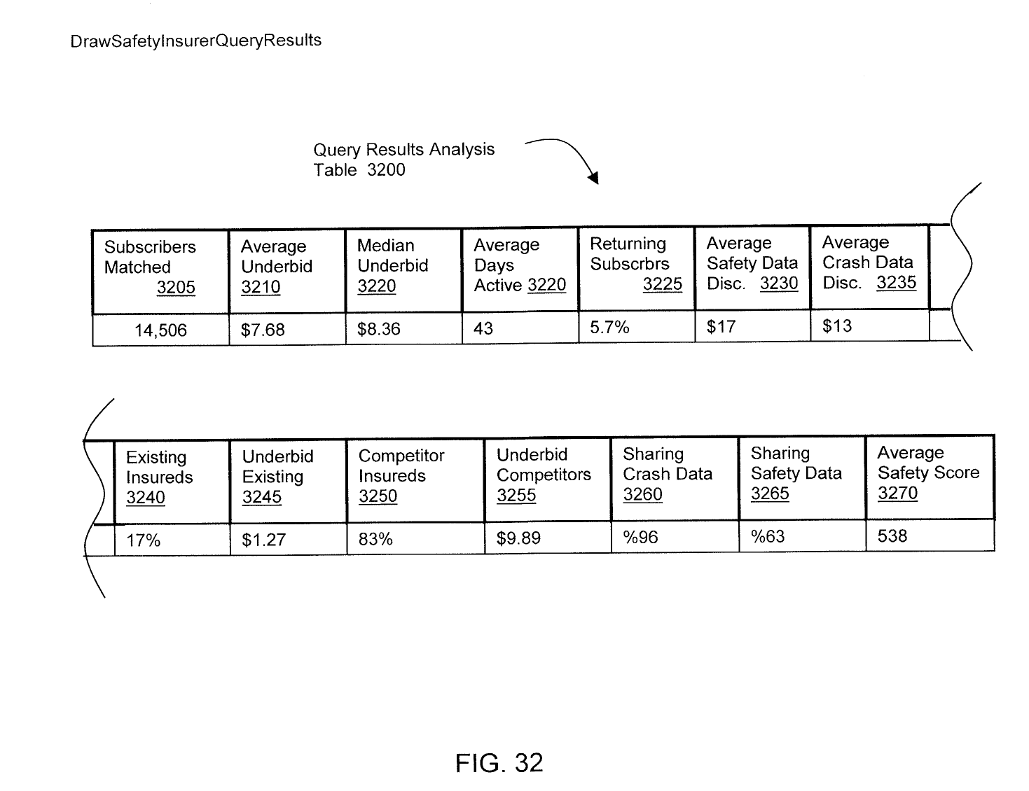

FIG. 32 illustrates an exemplary Query Results Analysis Table 3200 that may be returned to an Insurance Company 190 in response to a query of the Active Lead Database 950. The purpose of the Query Results Analysis Table 3200 is to provide the Insurance Company 190 detailed information regarding the effectiveness of its query criteria in meeting the requirements of the subscribers 170 in the Active Lead Database 950, as well as providing the Insurance Company 190 feedback regarding the competitiveness of its rating and underwriting criteria, insurance discount calculations and quality of Subscribers 170 meeting its query criteria. Subscribers Matched 3205 informs the Insurance Company 190 how many Subscribers in the Active Lead Database 950 matched the query criteria submitted by the Insurance Company 190. Average Underbid 3210 informs the Insurance Company of the average dollar amount by which the insurance company exceeded the ceiling quotation amount established by the subscriber to receive a quotation. Median Underbid 3215 informs the Insurance Company of the median dollar amount by which the insurance company exceeded the ceiling quotation amount established by the subscriber to receive a quotation. Average Days Active 3220 informs the Insurance Company 190 of the average number of days that the Subscribers in the query response had been active in the Active Lead Database 950. Returning Subscribers 3225 informs the Insurance Company 190 of the percentage of subscribers in the query response that have previously subscribed to insurance through this system. Average Safety Data Discount 3230 informs the Insurance Company 190 of the average discount that was calculated for the sharing of safety score data. Average Crash Data Discount 3235 informs the insurance Company 190 of the average discount that was calculated for the sharing of crash event data. Existing Insureds 3240 informs the Insurance Company of the percentage of subscribers meeting the query criteria that are currently policy holders of the Insurance Company 190. Underbid Existing 3245 informs the Insurance Company of the dollar amount by which the Insurance Company exceeded the ceiling quotation amount established by existing policy holders of the Insurance Company to receive a quotation. Competitor Insureds 3250 informs the Insurance Company of the percentage subscribers meeting the query criteria that are not current policy holders of the Insurance Company. Underbid Competitors 3255 informs the Insurance Company of the dollar amount by which the Insurance Company exceeded the ceiling quotation amount established by policy holders of its competitors to receive a quotation. Sharing Crash Data 3260 informs the Insurance Company of the percentage of subscribers meeting the query criteria that agreed to share crash event data. Sharing Safety Data 3265 informs the Insurance Company of the percentage of subscribers meeting the query criteria that agreed to share safety data. Average Safety Score 3270 informs the Insurance Company of the average Safety Score 870 of subscribers meeting the Insurance Company query criteria.

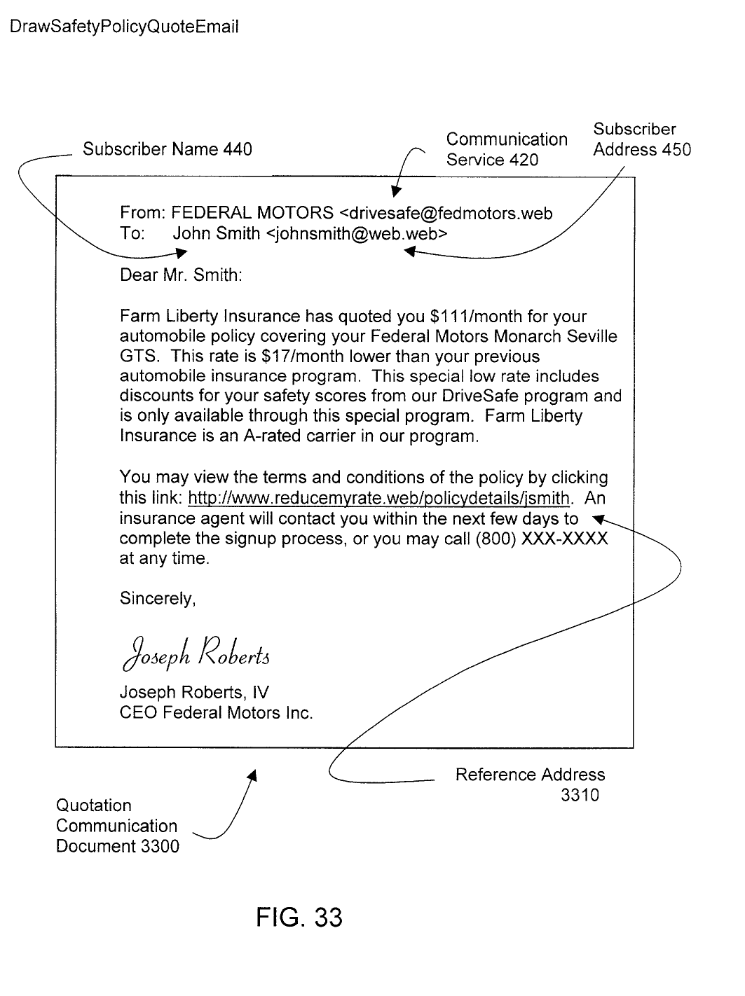

FIG. 33 illustrates an exemplary Quotation Communication Document 3300, here shown in the form of an email. The Communication Service 420 indicates the provider of the vehicle communication service from which the subscriber receives service. The Subscriber Name 440 and Subscriber Address 450, shown here as an email address, may be obtained from the Subscriber Database 115. A Reference Address 3310 is shown that directs the Subscriber 170 to a document containing the terms and conditions of the policy. Quotation Communication Document 3300 could take on other forms, including a mailer with a letter and copy of the policy terms and conditions.

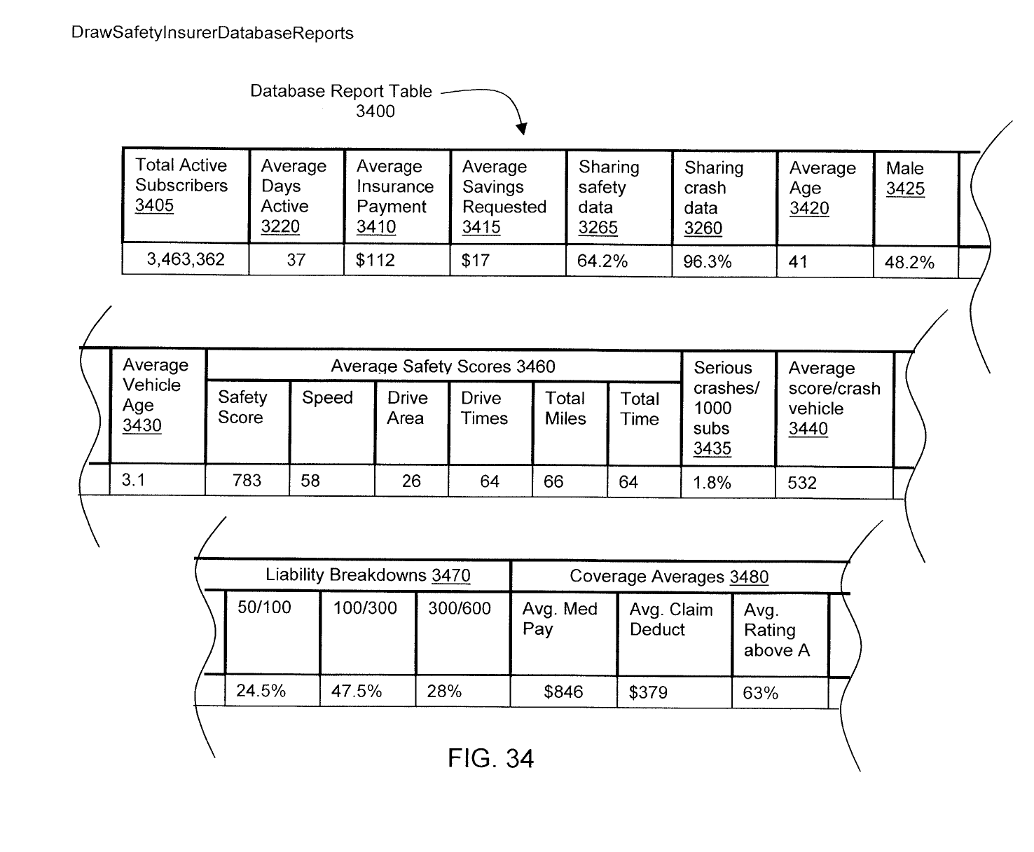

FIG. 34 is an exemplary Database Report Table 3400. The purpose of the Database Report Table 3400 is to provide Insurance Companies 190 and Insurance Data Experts 195 with statistical data regarding the records contained within the Active Lead Database 950. Total Active Subscribers 3405 represent the number of Subscribers 170 currently looking for insurance in the Active Lead Database 950. Average Days Active 3220 indicates the average number of days that Subscribers 170 have been active in the Active Lead Database 950. Average Insurance Payment 3410 represents the average insurance payment that active Subscribers 170 listed as their current payment. Average Savings Requested 3415 represent the average amount which a new quotation must fall under a Subscriber's 170 current payment in order for them to receive a quotation. Sharing Safety Data 3265 is shown a percentage of the Active Lead Database that has agreed to share Safety Scores 870 and Scaled Scores 860 with Insurance Companies 190. Sharing Crash Data 3260 is shown as a percentage of the Active Lead Database that has agreed to share crash event data with Insurance Companies 190. Average Age 3420 is shown as the average age of the Subscribers 170 in the Active Lead Database 950. Male 3425 is shown as the percentage of the Active Lead Database 950 that is male. Average Vehicle Age 3430 is shown as the average age of the vehicles listed in the Active Lead Database. Average Safety Scores 3460 represent averages of the Safety Scores 870 and-Scaled Scores 860 of the Subscribers 170 in the Active Lead Database 950. Serious Crashes/1000 Subs 3425 is shown as a measure of the ratio of Subscribers 170 in the Active Lead Database 950 that are on record as having been involved in a serious crash whereby crash event information was sent to their Insurance Company 190 per their authorization. Average Score/Crash Vehicle 3440 is shown as the average of the Safety Scores 870 of those Subscribers that have been involved in serious crashes whereby crash information was sent to their Insurance Company 190. Liability Breakdowns 3470 are shown as percentages of Subscribers within the Active Lead Database 950 requesting coverage of varying levels. Coverage Averages 3480 are shown as the average coverages requested, as well as a breakdown of the Insurance Company ratings required by Subscribers 170.

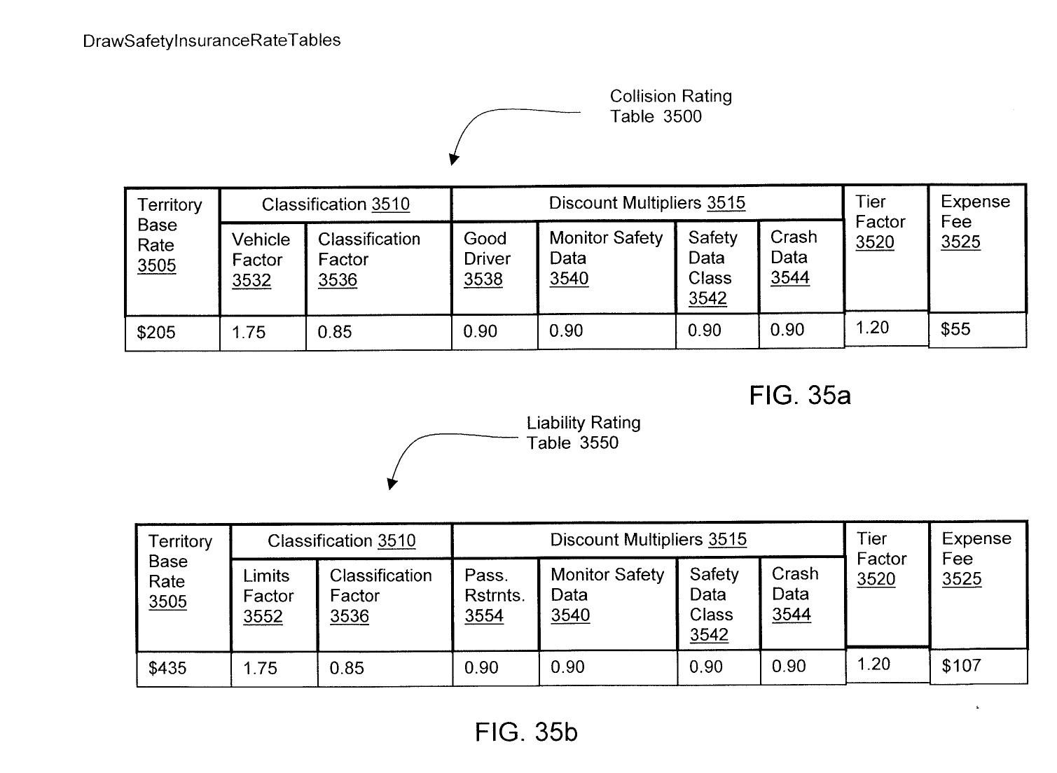

FIG. 35a and FIG. 35b show exemplary rating tables from a Rating Database 1660 of an Insurance Company 190. FIG. 35a shows a Collision Rating Table 3500 that may be utilized by an Insurance Company 190 to rate the collision coverage for a policy quotation. Collision Rating Table 3505 is shown as including a Territory Base Rate 3505, Classifications 3510, Discount Multipliers 3515, a Tier Factor 3520 and an Expense Fee 3525. Territory Base Rate 3505 represents a base rate for a particular coverage that is established based on the geographic area where the Subscriber 170 lives or works. Territory Base Rate 3505 could be a pricing structure based on claims experience in a particular geographic area, and could be based on any geographic area, such as a County, City or Zip Code. Classifications 3510 represent identifiable risk classes that are based on claims experience. Classifications 3510 is shown as including Vehicle Factor 3532 that corresponds to the value of the vehicle or the likelyhood that the vehicle will be involved in an accident based on claims experience. Classifications 3510 is also shown as including Classification Factor 3532 that corresponds to the likelyhood that the Subscriber 170 will be involved in an accident based on their age, marital status, employment or other demographic factors. Discount Multipliers 3515 represent various vehicle or driver attributes that either the Insurance Company 190 has chosen to provide discounts for, or that an Insurance Company 190 is required to provide a discount for pursuant to State law. Good Driver 3538 represents a discount that may be awarded based on recent participation in a defensive driving program. Monitor Safety Data 3540 represents a discount that may be awarded to Subscribers 170 that monitor their driving safety by receiving periodic information from the Data D&PS 130 regarding the risks posed by their vehicle operating characteristics. Safety Data Class 3542 represents a discount that may be awarded to Subscribers 170 based on their Safety Score 870 or Scaled Scores 860. Crash Data 3544 represents a discount that may be awarded to Subscribers 170 based on their authorization to share crash information with the Insurance Company 190. Tier Factor 3520 represents a risk factor used to adjust the price of a policy for a particular Subscriber 170 based on their accident or citation history. Expense Fee 3525 represents an amount that an Insurance Company 190 will add to the price of the policy based on the projected expenses of the Insurance Company 190.

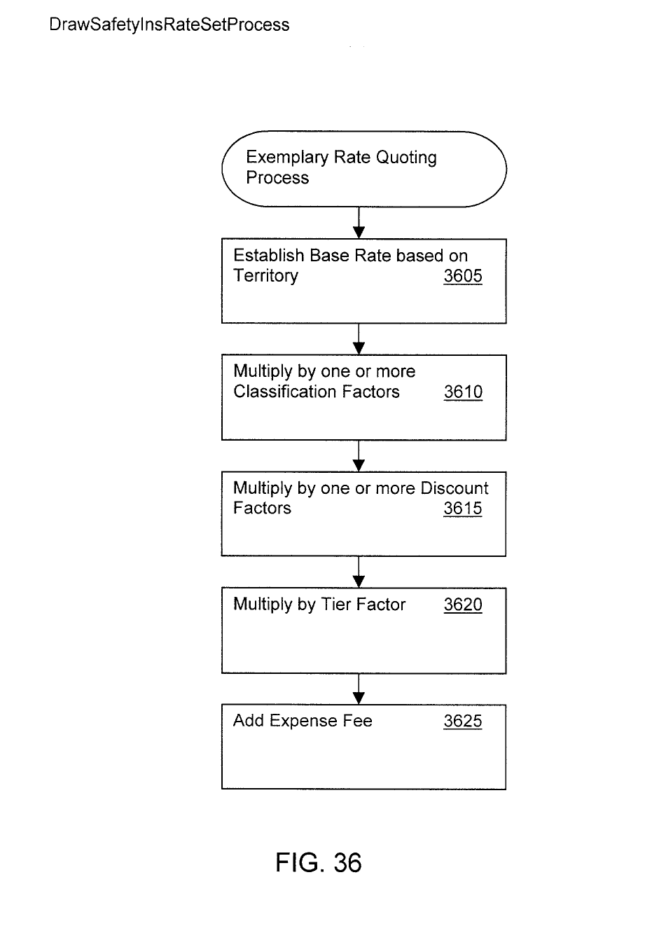

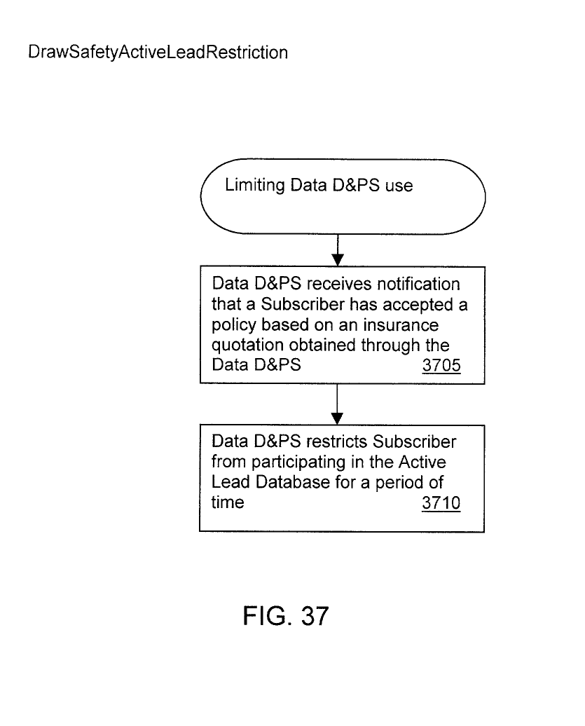

FIG. 35b shows a Liability Rating Table 3550 that may be used by an Insurance Company 190 to rate the liability coverage for a policy. Liability Rating Table 3550 may contain similar elements as the Collision Rating Table 3550. Here, Limits Factor 3552 represents an adjustment factor based on the amount of coverage sought by the Subscriber 170. Passenger Restraints 3554 represents a discount that may be awarded for having airbags in the subject vehicle. FIG. 36 illustrates an exemplary rate calculation process using the information from the above-described rating tables. In step 3605, a base rate is established based on the territory where the Subscriber 170 is located. Instep 3610 the base rate is successively multiplied values corresponding to the classification factors. In step 3615, the resulting rate is further successively multiplied by values corresponding to the discount factors. In step 3620 the resulting rate is multiplied by a tier factor, and in step 3625 the expense fee is added. The resulting product will be the rate for the particular Subscriber 170.

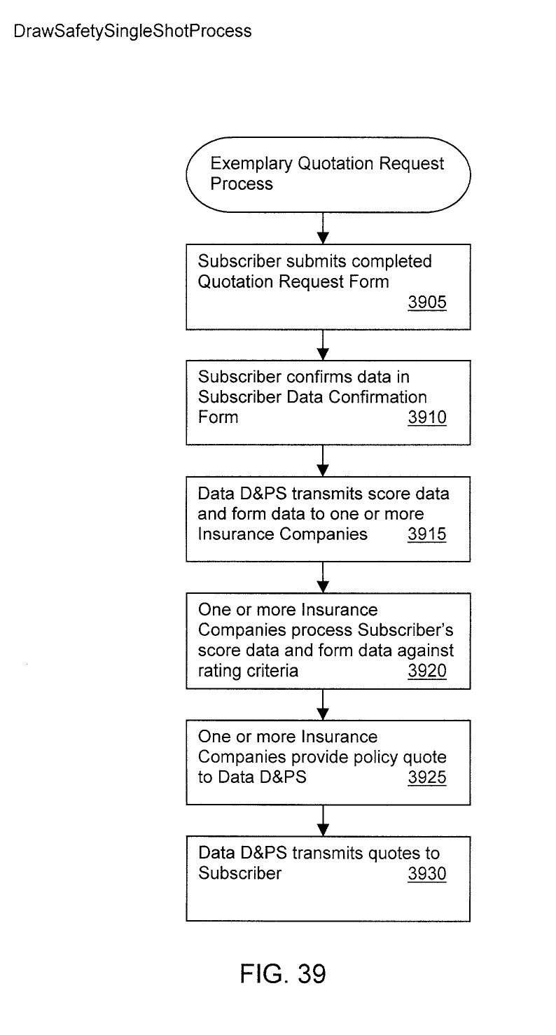

FIG. 39 illustrates an exemplary process for preventing over-use of the Data D&PS 130 by Subscribers 170 that subscribe to insurance through the Data D&PS 130. In step 3705 the Data D&PS 130 receives notification that a Subscriber 170 has accepted a policy from an Insurance Company 190 that was quoted using the Data D&PS 130. In step 3710, the Data D&PS 130 removes the Subscriber 170 from the Active Lead Database 950 and restricts the Subscriber 170 from re-entering the Active Lead Database 950 for a predetermined period of time.

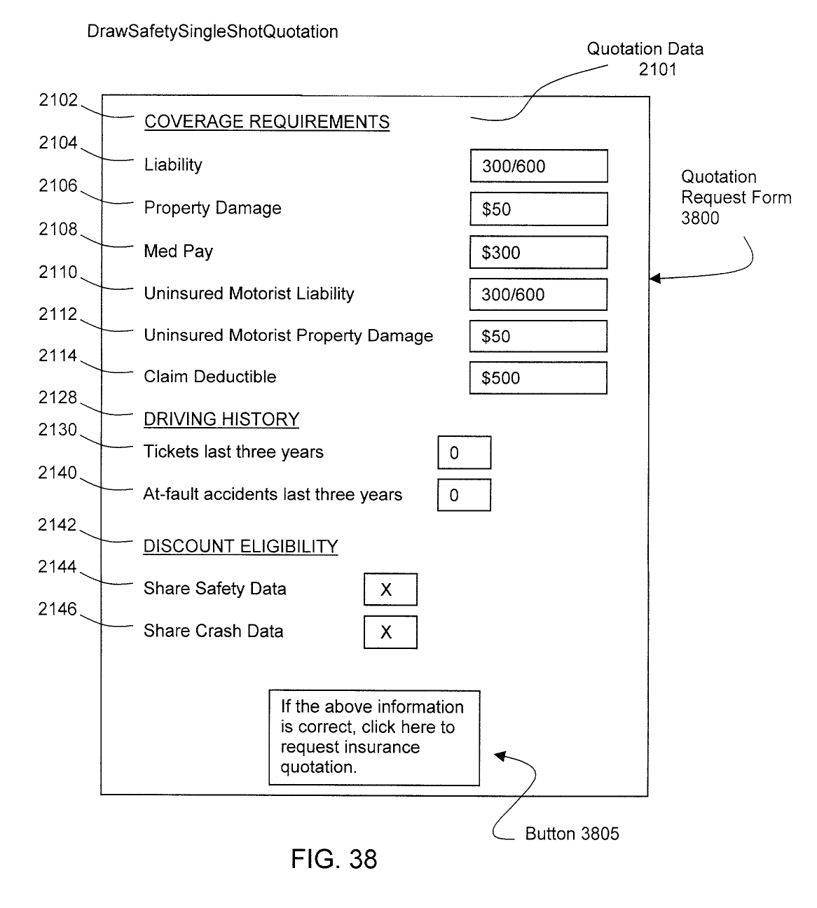

FIG. 38 and FIG. 39 show the process for a Subscriber 170 to request quotations at the time they are placed into the Active Lead Database 950. In FIG. 38, a Quotation Request Form 3800 is shown. The Quotation Request Form 3800 is similar to the Quotation Data Form 2100 in FIG. 21 only without Insurer Requirements 2116 or Pricing Requirements 2122. Most of the information fields in the Quotation Request Form 3800 may be filled with default variables to minimize data entry by the Subscriber 170. The Quotation Request Form 3800 can be a form located on a website. Once the Subscriber 170 has completed the Quotation Request Form 3800 and clicked on the Button 3805 with a computer pointing device, their request will be transmitted to one or more Insurance Companies 190 for quotation. Essentially the same Subscriber Data Confirmation Form 220 as is shown in FIG. 22 may be used to insure that Subscriber Data 117 is correct prior to requesting the quotation.

FIG. 39 is an illustration of a process for requesting and receiving a quotation in this manner. In step 3905 the Subscriber 170 completes the quotation request form. In step 3910 the subscriber confirms their subscriber data, and makes changes if necessary. In step 3915 the Data D&PS 130 transmits the score data and subscriber data for the subscriber to one or more insurance companies for quotation. In step 3920 the insurance companies evaluate the Subscriber's data against their rating criteria. In step 3925 the Insurance Companies provide the policy quote either directly to the subscriber based on their contact information or to the Data D&PS 130. If the quote is received by the Data D&PS 130, the quote is transmitted to the Data D&PS 130 as shown in step 3930.

Although the invention has been described and illustrated in detail, it is to be understood that the detail provided is by way of example and illustration, is not to be considered a limitation, and that modifications and changes therein may be made by those skilled in the art without departing from the spirit and scope of the invention. Accordingly, the scope of this invention is to be limited only by the appended claims.

We claim:

1. A method for abstracting on-board vehicle data, comprising:
receiving data from a sensor indicative of a specific operating characteristic of the vehicle; and
converting the data into an abstract score indicative of the specific operating characteristic of the vehicle over a period of time.

2. A method as claimed in claim I further comprising:
transmitting the abstract score to a remote location.

3. A method as claimed in claim 1 wherein the receiving and converting steps are repeated.

4. A method as claimed in claim 2 wherein the abstract score is transmitted periodically.

5. A method as claimed in claim 1 wherein the converting step comprises:
Processing the sensor data through an algorithm.

6. A method as claimed in claim 5 wherein the algorithm averages the sensor data with previously received sensor data.

6. A method as claimed in claim I wherein:
the receiving step comprises receiving data from a plurality of sensors; and
the converting step comprises converting the data into at least one abstract score.

7. The method of claim 1 wherein the period of time comprises a predetermined period of time.

8. The method of claim 1 wherein the sensor data is sampled at a predetermined frequency.

10. Apparatus for abstracting on-board vehicle data, the apparatus comprising:
a sensor for monitoring a specific operating characteristic of the vehicle; and
a processor for receiving data from the sensor and for converting the data into an abstract score indicative of the specific operating characteristic of the vehicle over a period of time.

11. A method of monitoring driving characteristics, comprising:
receiving an abstract score respectively from a plurality of vehicles, each of the abstract scores being indicative of at least one specific operating characteristic of the vehicle; and
generating a scale based on the abstract scores.

12. A method as claimed in claim 11 further comprising:
converting at least one of the abstract scores into a scaled score based on the scale.

13. A method as claimed in claim 12 wherein the converting step comprises comparing the abstract score with the scale.

14. A method as claimed in claim 11 wherein each abstract score is free of specific operating data.

15. A method as claimed in claim 12 further comprising:
cause an individual abstract score to be displayed in relation to the scaled abstract scores.

16. A method for monitoring driving characteristics of subscribers each operating a vehicle with at least one sensor for monitoring a specific operating characteristic of the vehicle, the method comprising:
receiving an abstract score from vehicle of each of the subscribers, each of the abstract scores being indicative of at least one specific operating characteristic of the vehicle;
generating a scale based on information correlating the abstract scores to risk measures;
converting each of the abstract scores into a scaled score based on the scale; and
transmitting the scaled score to each of the subscribers.

17. A method as claimed in claim 16 wherein each abstract score is free of specific operating data.

18. A method as claimed in claim 16 wherein the step of transmitting the scaled scores to each of the subscribers includes:
transmitting at least one of the scaled scores to a subscriber by email.

19. A method as claimed in claim 16 wherein the step of transmitting the scaled score to each of the subscribers includes:
placing the scaled score on a computer network that is accessible by the subscribers.

20. A method for predicting risk based on driving characteristics of a driver, the method comprising:
receiving a scaled score indicative of the driving characteristic, the scaled score being a comparison of the driving characteristic of the driver with risk measure information for the driving characteristic, the scaled score being free of specific operating charactericts; and
generating a risk factor for the driver based on the scaled score.

21. A method as claimed in claim 20 further comprising reducing the insurance rate of the driver if the risk factor is above or below a predetermined threshold.

22. A method as claimed in claim 20 further comprising:
calculating the scaled score from an abstract score, the abstract score being free of specific operating characteristics.

23. A method for enabling automatic insurance quotes for drivers who have subscribed to an automotive service in which subscriber data have been stored in a database, the subscriber data including personal and vehicle information, at least one of the drivers further subscribing to an insurance service, the method comprising:
maintaining a database that includes the subscriber data of the drivers subscribing to the insurance service; and
providing to an insurance company data including the subscriber data of drivers whose subscriber data meet predetermined criteria of the insurance company to enable the insurance company to generate an insurance quote for each of the drivers.

24. A method as claimed in claim 23 further comprising:
receiving a query from the insurance company, the query including the predetermined criteria.

25. A method as claimed in claim 23 further comprising:
receiving the subscriber data.

26. A method as claimed in claim 25 wherein the subscriber data includes coverage requirements.

27. A method as claimed in claim 25 wherein the subscriber data includes driver age.

28. A method as claimed in claim 23 further comprising:
providing the insurance company communication data of the driver to enable the insurance company to send the insurance quote directly to the driver.

29. A method as claimed in claim 23 further comprising:
receiving the insurance quote from the insurance company; and
providing the insurance quote to the respective driver.

30. A method for enabling automatic insurance quotes for drivers who have subscribed to an automotive service in which subscriber data have been stored in a database, the subscriber data including personal and vehicle information, at least one of the drivers further subscribing to an insurance service, the method comprising:
maintaining a database that includes the subscriber data of the drivers subscribing to the insurance service; and
providing to an insurance company data including the subscriber data of drivers to enable the insurance company to generate an insurance quote for each of the drivers.

31. A method as claimed in claim 30 further comprising:
receiving a query from the insurance company, the query including the predetermined criteria.

32. A method as claimed in claim 30 further comprising:
receiving the subscriber data.

33. A method as claimed in claim 32 wherein the subscriber data includes coverage requirements.

34. A method as claimed in claim 32 wherein the subscriber data includes data regarding the operating characteristics of the driver.

35. A method as claimed in claim 30 further comprising:
providing the insurance company communication data of the driver to enable the insurance company to send the insurance quote directly to the driver.

36. A method as claimed in claim 30 further comprising:
receiving the insurance quote from the insurance company; and
providing the insurance quote to the respective driver.

37. A method for managing of user data of drivers of vehicles who have subscribed to an automotive service, the user data including subscriber data and sensor data, the subscriber data including personal data and vehicle data, the sensor data including crash data, at least one of the drivers being a policy holder of an insurance company, the method comprising:
receiving crash data associated with one of the drivers who is a policy holder; and
providing claim data indicative of the crash data and the subscriber data associated with the crash data to the insurance company.

38. A method as claimed in claim 37 further comprising:
maintaining a database that includes the subscriber data of the drivers who are policy holders.

39. A method as claimed in claim 37 further comprising:
analyzing the crash data.

40. A method for insuring drivers of vehicles who have subscribed to an automotive service, the driver having the user data including subscriber data and sensor data, the subscriber data including personal data and vehicle data, the sensor data including crash data, the crash data being generated when the vehicle is in an accident, the method comprising:
issuing an insurance policy to a driver; and
receiving claim data indicative of the crash data and the subscriber data associated with the crash data automatically when crash data is generated.

41. A method as claimed in claim 40 wherein the issuing step comprises:
receiving an authorization from a driver to receive the crash data.

42. A method as claimed in claim 41 wherein the issuing step further comprises:
providing a discount on the insurance policy.

43. A method for insuring drivers of vehicles who have subscribed to an automotive service, the driver having the user data including subscriber data and sensor data, the subscriber data including personal data and vehicle data, the sensor data including crash data, the crash data being generated when the vehicle is in an accident, the method comprising:
receiving an authorization from a driver to receive crash data; and
providing a discount on the insurance policy.

44. A method for determining discounts for insurance policies based on abstract scores, each abstract score being indicative of a respective operating characteristic of a vehicle, the method comprising:
receiving a plurality of abstract scores;
comparing each of the abstract scores against a general population;
selecting at least one of the abstract scores based on the comparison against the general population;
calculating a discount on the at least one selected abstract score.

45. A method as claimed in claim 44 further comprising;
ranking the abstract scores based on importance;
the calculating step comprising calculating the discounted based on the ranked abstract scores.

46. A method as claimed in claim 45 wherein the ranking step comprises:
assigning a weighting factor to each of the ranked abstract scores.
